(19) United States
(12) Patent Application Publication
(10) Pub. No.: US 2017/0242288 A1
(43) Pub. Date: Aug. 24, 2017

(54) MANUFACTURIING METHOD FOR OPTOELECTRONIC DEVICE, OPTOELECTRONIC DEVICE, AND ELECTRONIC APPARATUS

(71) Applicant: SEIKO EPSON CORPORATION, Tokyo (JP)

(72) Inventors: Yuji SEKIGUCHI, Sapporo-shi (JP); Tomoya ISHIKAWA, Sapporo-shi (JP)

(73) Assignee: SEIKO EPSON CORPORATION, Tokyo (JP)

(21) Appl. No.: 15/428,619

(22) Filed: Feb. 9, 2017

(30) Foreign Application Priority Data
Feb. 18, 2016 (JP) 2016-028635
Aug. 29, 2016 (JP) 2016-166548

(51) Int. Cl. G02F 1/1333; G02F 1/1335; G02F 1/1339

(52) U.S. Cl. CPC G02F 1/133351; G02F 1/1339; G02F 1/133526; G02F 2202/28

(57) ABSTRACT

When an optoelectronic device is manufactured by splitting a composite substrate, a dicing process and a breaking process are performed for a first mother substrate in first splitting that splits the first mother substrate along the periphery of a seal material. A breaking process is performed for a second mother substrate in second splitting that splits the second mother substrate along the periphery of the seal material.

### BACKGROUND

1. Technical Field

The present invention relates to a manufacturing method for an optoelectronic device including a step of splitting a mother substrate, to an optoelectronic device, and to an electronic apparatus.

2. Related Art

In an optoelectronic device such as a liquid crystal device, a first substrate and a second substrate are bonded to each other by a seal material disposed in a frame shape, and an optoelectronic layer is disposed within a region surrounded by the seal material between the first substrate and the second substrate. In the manufacturing of such an optoelectronic device, a first mother substrate for acquiring the first substrate and a second mother substrate for acquiring the second substrate are bonded to each other by the seal material, and then the first mother substrate and the second mother substrate are split. At this point, when the first mother substrate is split at a part where planned split lines on the first mother substrate and on the second mother substrate overlap with each other, suggested is rendering a dicing saw to advance deeply from the outer surface of the first mother substrate until a cut is formed on the surface of the second mother substrate. In addition, mechanical processes such as a breaking process of cleaving a mother substrate along a groove formed by a scribe head and a dicing process using a dicing saw are used (refer to JP-A-2010-181696 and JP-A-2015-13782).

However, if the dicing saw is rendered to advance deeply until a cut is formed on the surface of the second mother substrate, vibration and the like of the dicing saw may cause damage to a sealed part such as the seal material or a film formed near the seal when the second mother substrate is cleaved by the dicing saw along the periphery of the seal material. Such damage causes a problem that moisture invades from the outside or a problem that a liquid crystal material used as the optoelectronic layer leaks to the outside, and thus is not preferable.

In addition, in the mechanical processes such as a breaking process and a dicing process, substrates may be subjected to chipping, burring, and the like, and the occurrence of such problems causes damage to terminals, interconnects, seal materials, and the like.

### SUMMARY

An advantage of some aspects of the invention is to provide a manufacturing method for an optoelectronic device, an optoelectronic device, and an electronic apparatus that can prevent damage to a seal material, a film formed near the seal material, or the like when a mother substrate is cleaved, and that can prevent occurrence of problems such as chipping and burring when the mother substrate is split.

According to an aspect of the invention, there is provided a manufacturing method for an optoelectronic device that manufactures the optoelectronic device by splitting a composite substrate in which a first mother substrate and a second mother substrate are bonded to each other by a seal material disposed in a frame shape, the method including first splitting that splits the first mother substrate along the periphery of the seal material, and second splitting that splits the second mother substrate along the periphery of the seal material, in which in the first splitting, a dicing process and a breaking process are performed for the first mother substrate, and in the second splitting, a second breaking process is performed for the second mother substrate.

In the manufacturing method for an optoelectronic device, in the first splitting, a dicing process of cleaving the first mother substrate from a first outer surface to a midway position in the thickness direction and a first breaking process of cleaving the first mother substrate from a groove formed on the first outer surface of the first mother substrate are performed, the first outer surface being a surface on the opposite side of the first mother substrate from the second mother substrate, and in the second splitting, a second breaking process of cleaving the second mother substrate from a groove formed on a second outer surface is performed, the second outer surface being a surface on the opposite side of the second mother substrate from the first mother substrate.

In the invention, a dicing process is performed in the first splitting that splits the first mother substrate along the periphery of the seal material. Thus, when the first mother substrate is split, a side surface that has an appropriate shape, an angle formed with the first outer surface, and the like can be acquired. In this case as well, a dicing process is performed to a midway position in the thickness direction, and the remaining part is split by a breaking process (first breaking process). Accordingly, a dicing saw advances shallowly, and thus what is unlikely occur is that vibration of the dicing saw damages the seal material or a film formed near the seal material. In addition, since a breaking process (second breaking process) is used in the second splitting that splits the second mother substrate along the periphery of the seal material, what is unlikely to occur is that vibration of the dicing saw at the time of the dicing process damages the seal material or a film formed near the seal material. Therefore, since damage to a seal portion can be prevented, invasion of moisture, leaking of an optoelectronic layer, and the like are unlikely to occur.

In the manufacturing method for an optoelectronic device, the seal material may be disposed in each of a first region and a second region that are adjacent in a first direction in the composite substrate, in the second splitting, the second mother substrate may be cleaved by the second breaking process along a first exterior line that extends in a second direction intersecting with the first direction along the periphery of the seal material, which is disposed in each of the first region and the second region, positioned on one side of the first direction, in the first splitting, the first mother substrate may be cleaved by the first breaking process along a second exterior line that extends in the second direction along the periphery of the seal material, which is disposed in each of the first region and the second region, positioned on the other side of the first direction, then the first mother substrate may be cleaved by the first breaking process along a third exterior line that extends in the second direction along the periphery of the seal material, which is disposed in each of the first region and the second region, positioned on the one side of the first direction, and thereby the first mother substrate may be split into each of the first region and the second region, an adhesive sheet may be bonded to the first outer surface when the first mother substrate is cleaved along the third exterior line, and after the first mother substrate is cleaved along the third exterior line, the first region and the second region may be peeled from the adhesive sheet in a state where the adhesive sheet is bonded to the first outer surface, and a split piece that is split by the second exterior line and the third exterior line in the first mother substrate may be rendered to remain on the adhesive sheet. In this case, an advantage that the split piece is not scattered is achieved.

In the manufacturing method for an optoelectronic device, after the first mother substrate is cleaved along the second exterior line, the second mother substrate may be cleaved along the first exterior line in a state where the adhesive sheet is bonded to the first outer surface, and then the first mother substrate may be cleaved along the third exterior line. In this case, when the first mother substrate is cleaved along the third exterior line, the split piece can be held by the adhesive sheet that is used when the second mother substrate is cleaved along the first exterior line.

In the manufacturing method for an optoelectronic device, the dicing process may be performed along the second exterior line and the third exterior line before the second mother substrate is cleaved along the first exterior line, and in cleaving of the first mother substrate along the third exterior line, the first breaking process may be performed from a groove that is formed along the third exterior line by the dicing process. In this case, since the dicing process can be collectively performed for the first mother substrate, the efficiency of production can be improved.

In the manufacturing method for an optoelectronic device, in the first splitting, at least a first laser scribing process of forming a crack by laser scribing from a first inner surface to a midway position toward a first outer surface and a dicing process of cleaving the first mother substrate by a dicing saw from the first outer surface to the crack are performed, the first inner surface being a surface on the second mother substrate side of the first mother substrate and the first outer surface being a surface on the opposite side of the first mother substrate from the second mother substrate, and in the second splitting, a second laser scribing process of forming a crack by laser scribing from a second outer surface to a second inner surface is performed, the second outer surface being a surface on the opposite side of the second mother substrate from the first mother substrate and the second inner surface being a surface on the first mother substrate side of the second mother substrate.

In the invention, laser scribing is used in splitting of the first mother substrate and the second mother substrate, and thus chipping, burring, and the like of substrates are unlikely to occur. Accordingly, what is unlikely to occur is that terminals, interconnects, seal materials, and the like are damaged due to chipping, burring, and the like of substrates. In addition, in using of laser scribing in splitting of the second mother substrate, a crack is formed by laser scribing from the first inner surface of the first mother substrate to a midway position, and the first mother substrate is cleaved by a dicing saw from the first outer surface to the crack. Thus, a section formed by the dicing saw exists in the first substrate split from the first mother substrate, and the position or the shape of such a section is highly accurate. Thus, when an optoelectronic device is mounted on an electronic apparatus, the position of the optoelectronic device can be aligned by using the section formed by the dicing saw as a reference.

In the first splitting, furthermore, a breaking process of cleaving the first mother substrate from a groove formed on the first outer surface may be performed. In the case of a breaking process, substrates can be efficiently cleaved by laser scribing. Accordingly, if a breaking process is used in cleaving of a location where damage to terminals, interconnects, seal materials, and the like is unlikely to occur, the efficiency of manufacturing can be increased compared with the case of cleaving the entire substrate by laser scribing.

Given that one direction extending along the first outer surface is a first direction and that a direction intersecting with the first direction along the first outer surface is a second direction, in the first splitting, first cleaving that cleaves the first mother substrate by the breaking process along a first exterior line extending in the second direction along the periphery of the seal material positioned on both sides of the first direction, second cleaving that cleaves the first mother substrate by the first laser scribing process and the dicing process along a second exterior line extending in the first direction along the periphery of the seal material positioned on both sides of the second direction, and third cleaving that cleaves the first mother substrate by the breaking process along a third exterior line extending on one side of the first direction in the seal material between the first exterior line and the seal material in the second direction along the periphery of the seal material positioned on the one side of the first direction may be performed, and in the second splitting, fourth cleaving that cleaves the second mother substrate by the second laser scribing process along a fourth exterior line extending in the second direction along the periphery of the seal material positioned on both sides of the first direction and fifth cleaving that cleaves the second mother substrate by the second laser scribing process along a fifth exterior line extending in the first direction along the periphery of the seal material positioned on both sides of the second direction may be performed.

When the first cleaving is performed after the second cleaving, the third cleaving, the fourth cleaving, and the fifth cleaving are performed, an adhesive sheet may be bonded to the first outer surface, the first mother substrate may be cleaved along the first exterior line, then an optoelectronic device that is split along the first exterior line, the second exterior line, the third exterior line, the fourth exterior line, and the fifth exterior line on the other side of the first direction in the seal material may be peeled from the adhesive sheet, and a split piece that is split by the first exterior line, the second exterior line, and the third exterior line on the one side of the first direction in the seal material in the first mother substrate may be rendered to remain on the adhesive sheet. In this case, an advantage that the split piece is not scattered is achieved.

According to another aspect of the invention, there is provided an optoelectronic device including a first substrate, a second substrate that faces the first substrate and includes a terminal in an extending portion extending from the first substrate toward one side of a first direction, a seal material of a frame shape that is disposed along a first side surface and bonds the first substrate and the second substrate to each other, the first side surface being a side surface of the first substrate, and an optoelectronic layer that is disposed between the first substrate and the second substrate, in which the first side surface includes a first part from a first inner surface to a midway position toward a first outer surface and a second part from the midway position to the first outer surface, the first inner surface being a surface on the second substrate side of the first substrate and the first outer surface being a surface on the opposite side of the first substrate from the second substrate.

In the optoelectronic device, the first side surface includes the first part that is formed from the first outer surface, which is a surface on the opposite side of the first substrate from the second substrate, to a midway position in the thickness direction and the second part that is formed to the first inner surface, which is a surface on the second substrate side of the first substrate, on the second substrate side of the first part and has lower light-scattering ability than the first part, and a part of a second side surface that extends along the seal material includes a third part that is from a second inner surface to a midway position in the thickness direction and has lower light-scattering ability than the first part, the second side surface being a side surface of the second substrate and the second inner surface being a surface on the first substrate side of the second substrate.

In the invention, a cleaved surface that is formed by a breaking process has lower light-scattering ability than a section formed by a dicing process. Thus, the first side surface of the first substrate includes a section (first part) formed by a dicing process and a section (second part) formed by a breaking process. Accordingly, since a dicing process is performed when the first substrate is acquired, the first part having an appropriate shape, an angle formed with the first outer surface, and the like can be disposed in the first side surface when the first mother substrate is split. In this case as well, a dicing process is performed to a midway position in the thickness direction, and the remaining part is a cleaved surface (second part) formed by a breaking process (first breaking process). Accordingly, a dicing saw advances shallowly, and thus what is unlikely occur is that vibration of the dicing saw damages the seal material or a film formed near the seal material. In addition, since a breaking process is used when the second substrate is acquired, what is unlikely to occur is that a seal portion is damaged by the dicing saw. Therefore, invasion of moisture, leaking of the optoelectronic layer, and the like caused by damage in the seal portion are unlikely to occur.

In the optoelectronic device, the first side surface includes the first part that is formed from the first outer surface, which is a surface on the opposite side of the first substrate from the second substrate, to a midway position in the thickness direction, a step portion that is adjacent to the first part on the second substrate side, and the second part that is formed from the step portion to the first inner surface, which is a surface on the second substrate side of the first substrate, and protrudes to the opposite side of the first part from the optoelectronic layer, and a part of a second side surface that extends along the seal material includes a third part that is formed from a second outer surface to a midway position in the thickness direction and a fourth part that is formed from the third part to a second inner surface and is recessed to the optoelectronic layer side of the third part, the second side surface being a side surface of the second substrate, the second outer surface being a surface on the opposite side of the second substrate from the first substrate, and the second inner surface being a surface on the first substrate side of the second substrate.

In the invention, a section that is formed by a dicing process is recessed more than a cleaved surface formed by a breaking process due to the thickness of the blade of a dicing saw. Thus, the first side surface of the first substrate includes a section (first part) formed by a dicing process and a cleaved surface (second part) formed by a breaking process. That is, a dicing process is performed when the first substrate is acquired. Thus, when the first mother substrate is split, the first part having an appropriate shape, an angle formed with the first outer surface, and the like can be disposed in the first side surface. In this case as well, a dicing process is performed to a midway position in the thickness direction, and the remaining part is a cleaved surface (second part) formed by a breaking process (first breaking process). Accordingly, a dicing saw advances shallowly, and thus what is unlikely occur is that vibration of the dicing saw damages the seal material or a film formed near the seal material. In addition, since a breaking process is used when the second substrate is acquired, what does not occur is that a seal portion is damaged by the dicing saw. Therefore, invasion of moisture, leaking of the optoelectronic layer, and the like caused by damage in the seal portion are unlikely to occur.

In the optoelectronic device, of the first side surfaces, either of a surface positioned on both sides of the first direction and a surface positioned on both sides of a second direction intersecting with the first direction includes the first part from the first inner surface, which is a surface on the second substrate side of the first substrate, to a midway position toward the first outer surface, which is a surface on the opposite side of the first substrate from the second substrate, and the second part from the midway position to the first outer surface, and the periphery of the first substrate including the first part has a greater planar size than the periphery of the first substrate including the second part.

In the optoelectronic device, of the second side surfaces which are side surfaces of the second substrate, either a surface positioned on the other side of the first direction or surfaces positioned on both sides of the second direction may overlap with the first part in a plan view.

A thermally modified part of a spot shape may be distributed in the first part, the thermally modified part may not be distributed in the second part, and the thermally modified part may be distributed in, of the second side surfaces which are side surfaces of the second substrate, either surfaces positioned on both sides of the first direction or surfaces positioned on both sides of the second direction from the second inner surface, which is a surface on the first substrate side of the second substrate, to the second outer surface, which is a surface on the opposite side of the second substrate from the first substrate. In laser scribing, a part that is irradiated with a laser spot is thermally modified, and the stress generates a crack. Accordingly, if a thermally modified part of a spot shape exists in the first substrate and the second substrate, it is understood that laser scribing is used in splitting of the first mother substrate and the second mother substrate.

In the optoelectronic device, the first part and the second part may exist in, of the first side surfaces, surfaces positioned on both sides of the second direction, and the thermally modified part may also be distributed in, of the second side surfaces, either surfaces positioned on both sides of the first direction or surfaces positioned on both sides of the second direction.

In the optoelectronic device, of the first side surfaces, surfaces positioned on both sides of the first direction may include a third part that is formed from the first outer surface to a midway position toward the first inner surface and a fourth part that is from the third part to the first inner surface and has lower light-scattering ability than the third part. Since a cleaved surface formed by a breaking process has lower light-scattering ability than a section formed by a dicing process, if the third part and the fourth part exist, it is understood that a groove is formed by a dicing saw from the first outer surface.

The optoelectronic device to which the invention is applied is used in various electronic apparatuses. Such electronic apparatuses include, for example, an illuminant unit that renders light to be incident on the optoelectronic device from the element substrate side. In addition, in the case of using the optoelectronic device in a projection display apparatus of the various electronic apparatuses, an illuminant unit that emits light supplied to the optoelectronic device and a projection optical system that projects light modulated by the optoelectronic device are disposed in the projection display apparatus.

### BRIEF DESCRIPTION OF THE DRAWINGS

The invention will be described with reference to the accompanying drawings, wherein like numbers reference like elements.

FIG. 1 is a plan view when an optoelectronic device to which the invention is applied is seen from a first substrate side thereof.

FIG. 2 is a Y0-Y0′ sectional view of the optoelectronic device illustrated in FIG. 1.

FIG. 3 is a descriptive diagram in which end portions on both sides in a Y direction of the optoelectronic device illustrated in FIG. 1 are illustrated in an enlarged manner.

FIG. 4 is a descriptive diagram in which end portions on both sides in an X direction of the optoelectronic device illustrated in FIG. 1 are illustrated in an enlarged manner.

FIG. 5 is a plan view of a composite substrate that is used in a manufacturing method for the optoelectronic device illustrated in FIG. 1.

FIG. 6 is a plan view in which a part of the composite substrate illustrated in FIG. 5 is illustrated in an enlarged manner.

FIG. 7 is a sectional view in which a part of the composite substrate illustrated in FIG. 5 is illustrated in an enlarged manner.

FIG. 8 is a sectional step view illustrating the manufacturing method for the optoelectronic device illustrated in FIG. 1.

FIG. 9 is a sectional step view illustrating the manufacturing method for the optoelectronic device illustrated in FIG. 1.

FIG. 10 is a schematic configuration diagram of a projection display apparatus (electronic apparatus) in which the optoelectronic device illustrated in FIG. 1 is used.

FIG. 11 is a plan view when an optoelectronic device is seen from a first substrate side thereof.

FIG. 12 is a Y0-Y0′ sectional view of the optoelectronic device illustrated in FIG. 11.

FIG. 13 is a descriptive diagram in which end portions on both sides in a Y direction of the optoelectronic device illustrated in FIG. 11 are illustrated in an enlarged manner.

FIG. 14 is a descriptive diagram in which end portions on both sides in an X direction of the optoelectronic device illustrated in FIG. 11 are illustrated in an enlarged manner.

FIG. 15 is a plan view of a composite substrate that is used in a manufacturing method for the optoelectronic device illustrated in FIG. 11.

FIG. 16 is a plan view in which a part of the composite substrate illustrated in FIG. 15 is illustrated in an enlarged manner.

FIG. 17 is a sectional view in which a part of the composite substrate illustrated in FIG. 15 is illustrated in an enlarged manner.

FIG. 18 is a sectional step view illustrating the manufacturing method for the optoelectronic device illustrated in FIG. 11.

FIG. 19 is a sectional step view illustrating the manufacturing method for the optoelectronic device illustrated in FIG. 11.

FIG. 20 is a schematic configuration diagram of a projection display apparatus (electronic apparatus) in which the optoelectronic device illustrated in FIG. 11 is used.

### DESCRIPTION OF EXEMPLARY EMBODIMENTS

### First Embodiment

A liquid crystal device which is a representative optoelectronic device will be described as a first embodiment of the invention. In the drawings referred to in the following description, different scales are used for each layer or for each member in order for each layer or each member to have a size recognizable on the drawings.

### Configuration of Optoelectronic Device

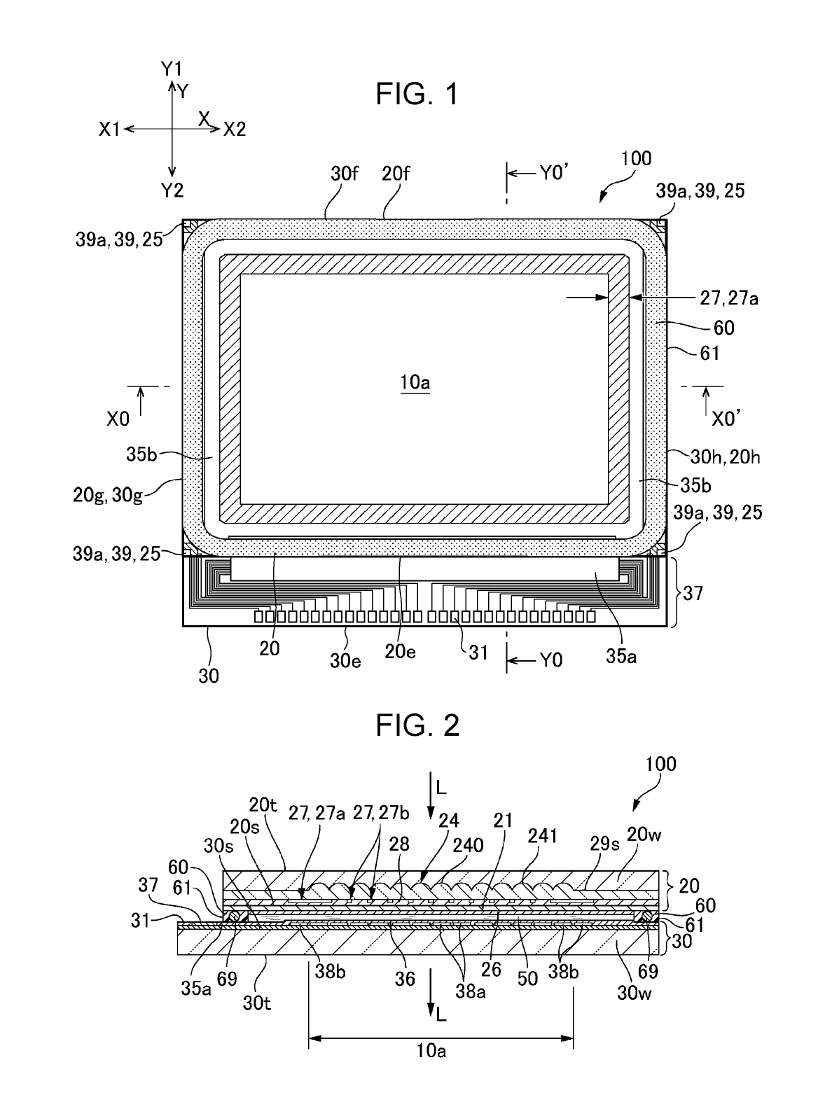

FIG. 1 is a plan view when an optoelectronic device 100 to which the invention is applied is seen from the first substrate 20 side thereof, and FIG. 2 is a Y0-Y0′ sectional view of the optoelectronic device illustrated in FIG. 1. In the following description, a Y direction corresponds to a “first direction” in the invention, and an X direction corresponds to a “second direction” in the invention.

The optoelectronic device 100 illustrated in FIG. 1 and FIG. 2 is a liquid crystal device in which a first substrate 20 (opposite substrate) and a second substrate 30 (element substrate) are bonded to each other by a seal material 60 extending along the periphery of the first substrate 20. The seal material 60 is configured of an adhesive such as light-curable resin, thermosetting resin, or anaerobic curable resin. In the optoelectronic device 100, a liquid-phase optoelectronic layer 50 that is configured of a liquid crystal material is disposed within a region surrounded by the seal material 60 between the first substrate 20 and the second substrate 30, and the seal material 60 bonds the first substrate 20 and the second substrate 30 to each other and seals the optoelectronic layer 50. The seal material 60 contains a gapping material 69, and the gapping material 69 controls the gap between the first substrate 20 and the second substrate 30 (the thickness of the optoelectronic layer 50).

In the present embodiment, a liquid crystal drop injection method (one drop fill (ODF) method) is used in disposing of the optoelectronic layer 50. In such a method, for example, the seal material 60 is disposed on a side of the second substrate 30, after which a liquid-phase optoelectronic material is dropped on the inner side of the seal material 60, and then the first substrate 20 and the second substrate 30 are bonded to each other. Thus, the seal material 60 is continuous on the entire periphery. The first substrate 20 may be bonded to the second substrate 30 in a state where a part of the seal material 60 is disconnected, and then a liquid-phase optoelectronic material may be injected in a vacuum from the disconnected part of the seal material 60. In this case, the disconnected part of the seal material 60 is filled with a sealant.

In the optoelectronic device 100, a substrate main body 20w of the first substrate 20 and a substrate main body 30w of the second substrate 30 are light-transmissive substrates such as glass or quartz substrates. In addition, either of the first substrate 20 (substrate main body 20w) and the second substrate 30 (substrate main body 30w) has a quadrangular shape in a plane (XY plane) with a thickness of approximately less than 1 mm and has side surfaces on four edges thereof. Given that a side surface of the first substrate 20 is a first side surface, the first substrate 20 includes two facing first side surfaces 20e and 20f in the Y direction and two facing first side surfaces 20g and 20h in the X direction. In addition, given that a side surface of the second substrate 30 is a second side surface, the second substrate 30 includes two facing second side surfaces 30e and 30f in the Y direction and two facing second side surfaces 30g and 30h in the X direction. A display region 10a is disposed as a quadrangular region in an approximate center of the optoelectronic device 100.

In the optoelectronic device 100, the first substrate 20 is smaller than the second substrate 30, and the seal material 60 and the second substrate 30 are disposed in a position shifted to a one side Y1 of the Y direction in the first substrate 20. Thus, the second substrate 30 has an extending portion 37 that extends from the first substrate 20. Specifically, the second substrate 30 extends from the first side surface 20e of the first substrate 20 and has the extending portion 37 between the second side surface 30e of the second substrate 30 and the first side surface 20e of the first substrate 20. Meanwhile, either of the first side surface 20f and the second side surface 30f overlaps with a periphery 61 of the seal material 60 in a plan view on the one side Y1 of the Y direction. Either of the first side surface 20g and the second side surface 30g overlaps with the periphery 61 of the seal material 60 in a plan view on a one side X1 of the X direction. Either of the first side surface 20h and the second side surface 30h overlaps with the periphery 61 of the seal material 60 in a plan view on an other side X2 of the X direction.

In the second substrate 30, a data line drive circuit 35a and a plurality of terminals 31 are formed in a region outside of the display region 10a on an other side Y2 of the Y direction, and the terminal 31 is arranged along the second side surface 30e in the extending portion 37. In addition, a scan line drive circuit 35b is formed in the second substrate 30 along each of the second side surfaces 30g and 30h. A flexible interconnect substrate (not illustrated) is connected to the terminal 31, and through the flexible interconnect substrate, various electrical potentials or various signals are input from an external control circuit to the second substrate 30.

The first substrate 20 has a first inner surface 20s that is a surface on the second substrate 30 side thereof, and a first outer surface 20t that is a surface on the opposite side thereof from the second substrate 30 side. A common electrode 21 is formed on the first inner surface 20s.

The second substrate 30 has a second inner surface 30s that is a surface on the first substrate 20 side thereof, and a second outer surface 30t that is a surface on the opposite side thereof from the second substrate 30 side. On the second inner surface 30s side of the second substrate 30, a pixel electrode 38a, a pixel transistor (not illustrated), and the like are arranged in a matrix in the display region 10a. A dummy pixel electrode 38b that is formed at the same time as the pixel electrode 38a is formed in a region surrounded by the display region 10a and the first side surfaces 20e, 20f, 20g, and 20h of the first substrate 20 on the second inner surface 30s of the second substrate 30. The dummy pixel electrode 38b to which a common electrical potential Vcom is applied prevents orientation of liquid crystal molecules from being disturbed in a peripheral side end portion of the display region 10a. An oriented film 36 is formed as a layer above the pixel electrode 38a and the dummy pixel electrode 38b.

In the first substrate 20, the common electrode 21 is formed on an approximately entire surface of the display region 10a or across a plurality of pixels as a plurality of band-shaped electrodes. In the present embodiment, the common electrode 21 is formed on the entire surface of a rectangular region that includes the display region 10a. On the first inner surface 20s of the first substrate 20, a protective film 28 and a light blocking layer 27 are formed below the common electrode 21, and an oriented film 26 is stacked on the surface of the common electrode 21. The light blocking layer 27 is formed as a frame part 27a that extends along the periphery of the display region 10a, and the inner periphery of the light blocking layer 27 defines the display region 10a. In addition, the light blocking layer 27 is formed as a black matrix portion 27b that overlaps with an inter-pixel region surrounded by the adjacent pixel electrodes 38a.

An inter-substrate conduction electrode 25 is formed near four corners of the first inner surface 20s of the first substrate 20, and an inter-substrate conduction electrode 39 is formed in a position facing the inter-substrate conduction electrode 25 of the first substrate 20 on the second inner surface 30s of the second substrate 30. In the present embodiment, the inter-substrate conduction electrode 25 is configured of a part of the common electrode 21. An inter-substrate conductive material 39a that includes conductive particles such as silver is arranged between the inter-substrate conduction electrode 39 and the inter-substrate conduction electrode 25, and the common electrode 21 of the first substrate 20 is electrically connected to the second substrate 30 side through the inter-substrate conduction electrode 39, the inter-substrate conductive material 39a, and the inter-substrate conduction electrode 25. Thus, the common electrical potential Vcom is applied from the second substrate 30 side to the common electrode 21.

### Configuration of Lens 24

The first substrate 20 is configured as a lens array substrate in which a plurality of lenses 24 that overlaps in a one-to-one relationship with each of a plurality of the pixel electrodes 38a in a plan view (a state where the first substrate 20 is seen from a direction perpendicular to the XY plane), and the lens 24 has a function of effectively guiding light to an opening region of the second substrate 30. In the present embodiment, a lens surface 240 that is configured of a rough surface or a convex surface is formed in the substrate main body 20w, and a lens layer 241 is stacked on the lens surface 240. In the present embodiment, the lens surface 240 is configured of a concave surface. In addition, the lens layer 241 has a greater refractive index than the substrate main body 20w. Thus, the lens surface 240 functions as the lens 24 that has positive power.

In the present embodiment, the optoelectronic device 100 is a transmissive liquid crystal device, and the pixel electrode 38a and the common electrode 21 are formed of light-transmissive conductive films such as an indium tin oxide (ITO) film and an indium zinc oxide (IZO) film. In such a transmissive liquid crystal display (optoelectronic device 100), for example, light that is incident from the outer surface 20t of the first substrate 20 is modulated while being emitted from the second substrate 30, as illustrated by an arrow L in FIG. 2, and thereby an image is displayed. In a case where the optoelectronic device 100 is a reflective liquid crystal device, the common electrode 21 is formed of a light-transmissive conductive film such as an ITO film or an IZO film, and the pixel electrode 38a is formed of a reflective conductive film such as an aluminum film. In such a reflective liquid crystal display (optoelectronic device 100), light that is incident from the outer surface 20t of the first substrate 20 is modulated while being emitted after reflected by the second substrate 30, and thereby an image is displayed.

The optoelectronic device 100 can be used as a color display device for an electronic apparatus such as a mobile computer and a mobile phone. In this case, a color filter (not illustrated) is formed in the first substrate 20. In addition, the optoelectronic device 100 can be used as electronic paper. In addition, in the optoelectronic device 100, a polarization film, a retarder film, a polarization plate, and the like are arranged in a predetermined direction with respect to the optoelectronic device 100 according to the type of the optoelectronic layer 50 (liquid crystal material) used or a normally white mode/normally black mode. Furthermore, the optoelectronic device 100 can be used as an RGB light valve in a projection display apparatus (liquid crystal projector) described later. In this case, light of each color that is separated through an RGB color separation dichroic mirror is individually incident as projected light on each optoelectronic device 100 for RGB, and thus a color filter is not formed.

### Configuration of First Side Surfaces 20e to 20h of First Substrate 20 and Like

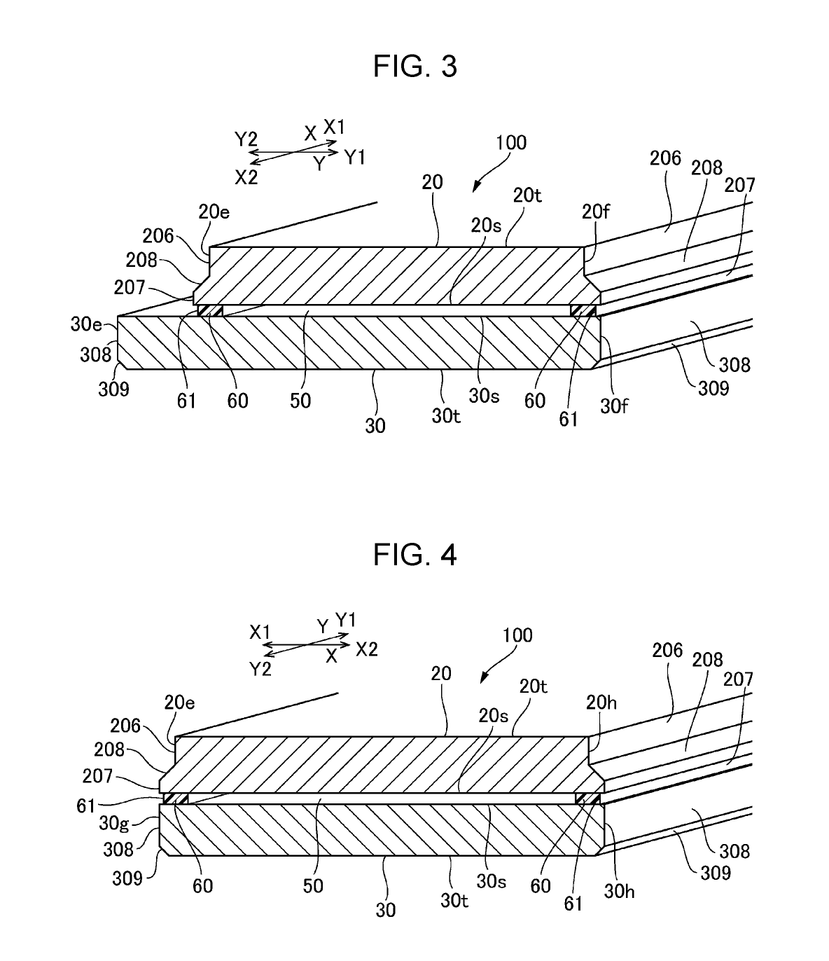

FIG. 3 is a descriptive diagram in which end portions on both sides in the Y direction of the optoelectronic device 100 illustrated in FIG. 1 are illustrated in an enlarged manner, and FIG. 3 corresponds to the Y0-Y0′ section. FIG. 4 is a descriptive diagram in which end portions on both sides in the X direction of the optoelectronic device 100 illustrated in FIG. 1 are illustrated in an enlarged manner, and FIG. 4 corresponds to an X0-X0′ section.

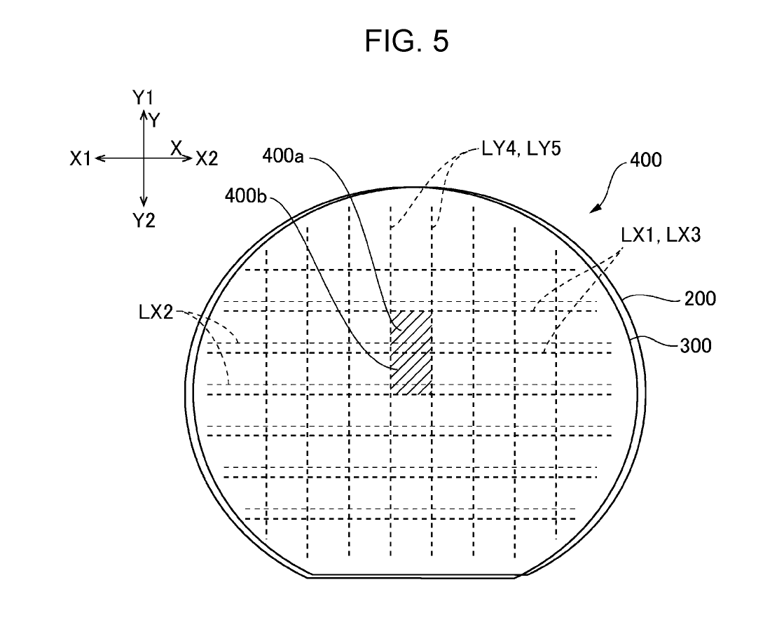

The optoelectronic device 100 of the present embodiment is manufactured by a method that is described later with reference to FIG. 5 to FIG. 9. Thus, the first side surfaces 20e, 20f, 20g, and 20h of the first substrate 20 and the second side surfaces 30e, 30f, 30g, and 30h of the second substrate 30 have the following configuration as illustrated in FIG. 3 and FIG. 4.

First, the first side surfaces 20e, 20f, 20g, and 20h of the first substrate 20 extend along the periphery 61 of the seal material 60. All of the first side surfaces 20e, 20f, 20g, and 20h have a first part 206 that is formed from the first outer surface 20t of the first substrate 20 to a midway position in the thickness direction, and a second part 207 that is formed to the first inner surface 20s on the second substrate 30 side of the first part 206. The second part 207 has lower light-scattering ability than the first part 206. That is, the first part 206 is a section formed by a dicing process, and a mark of a dicing saw remains as fine roughness at the time of cleaving, and thus the first part 206 has high light-scattering ability. Meanwhile, the second part 207 is configured of a cleaved surface that starts from a groove formed on the first outer surface 20t in a breaking process and reaches the first inner surface 20s, and the second part 207 is an approximately specular surface. Thus, the second part 207 has lower light-scattering ability than the first part 206.

In addition, in all of the first side surfaces 20e, 20f, 20g, and 20h, a step portion 208 is formed between the first part 206 and the second part 207, and the second part 207 protrudes to the opposite side of the first part 206 from the optoelectronic layer 50. That is, since the first part 206 is recessed to the optoelectronic layer 50 side of the second part 207 due to the thickness of the blade of the dicing saw, the second part 207 protrudes to the opposite side of the first part 206 from the optoelectronic layer 50.

In addition, the second side surfaces 30f, 30g, and 30h of the second side surfaces 30e, 30f, 30g, and 30h of the second substrate 30 extend along the periphery 61 of the seal material 60. In the present embodiment, all of the second side surfaces 30f, 30g, and 30h of the second substrate 30 include a third part 308 from the second inner surface 30s of the second substrate 30 to a midway position in the thickness direction, and the third part 308 has lower light-scattering ability than the first part 206. That is, the third part 308 is configured of a cleaved surface that is formed by a breaking process. In the present embodiment, all of the second side surfaces 30e, 30f, 30g, and 30h of the second substrate 30 include the third part 308.

In addition, in the second substrate 30, all of the second side surfaces 30f, 30g, and 30h extending along the seal material 60 include a fourth part 309 from the third part 308 to the second outer surface 30t, and the fourth part 309 is recessed to the optoelectronic layer 50 side of the third part 308. The fourth part 309 is configured of a scribe groove that is formed on the second outer surface 30t for a breaking process. In the present embodiment, all of the second side surfaces 30e, 30f, 30g, and 30h of the second substrate 30 include the third part 308 and the fourth part 309.

### Configuration of Composite Substrate 400 and Exterior Line

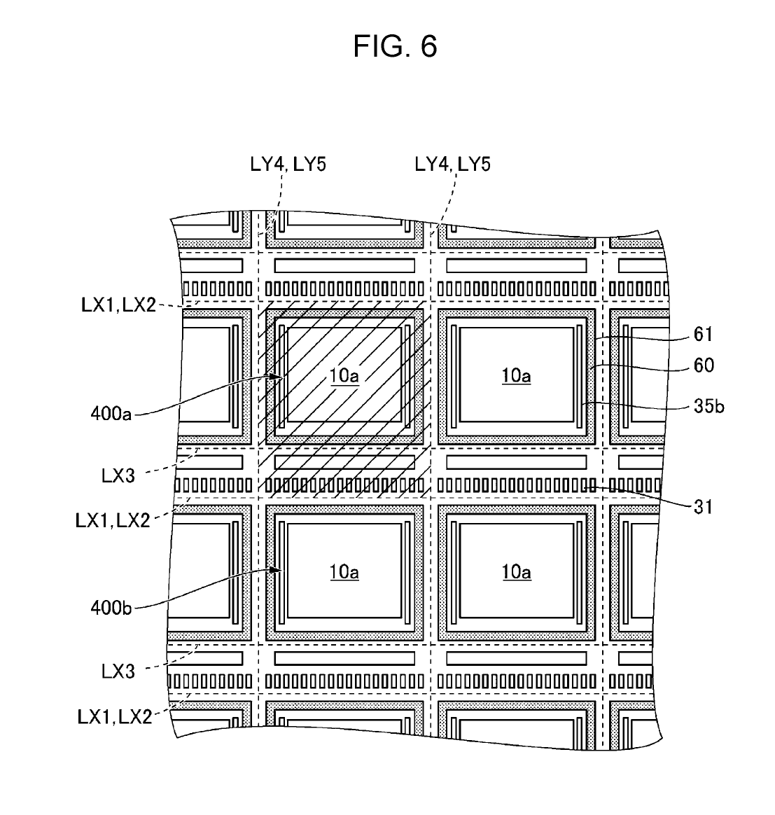

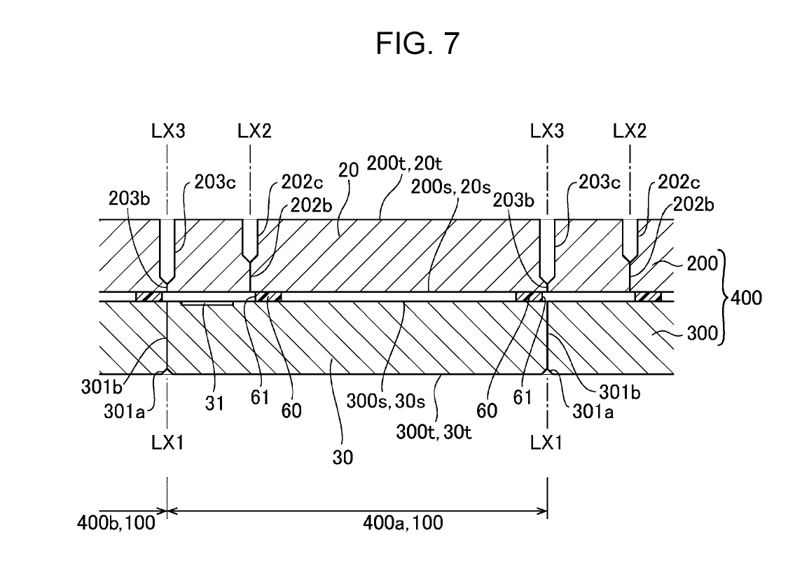

FIG. 5 is a plan view of a composite substrate 400 that is used in a manufacturing method for the optoelectronic device 100 illustrated in FIG. 1. The composite substrate 400 is configured of a first mother substrate 200 and a second mother substrate 300. FIG. 6 is a plan view in which a part of the composite substrate 400 illustrated in FIG. 5 is illustrated in an enlarged manner. FIG. 7 is a sectional view in which a part of the composite substrate 400 illustrated in FIG. 5 is illustrated in an enlarged manner, and FIG. 7 corresponds to a sectional view taken along the line Y0-Y0′ illustrated in FIG. 1 and the like. In FIG. 5, in order to easily recognize the first mother substrate 200 and the second mother substrate 300, each end portion thereof is illustrated as being shifted from each other. In addition, in FIG. 6, in order to easily recognize the exterior line, the exterior line and the seal material 60 are illustrated as being separated from each other more than in reality.

In manufacturing steps for the optoelectronic device 100 described with reference to FIG. 1 and the like, the first mother substrate 200 from which the first substrate 20 can be acquired in multiple numbers and the second mother substrate 300 from which the second substrate 30 can be acquired in multiple numbers are prepared as illustrated in FIG. 5. Next, the common electrode 21 and the like are formed in each of a plurality of regions that is split as the first substrate 20 in the first mother substrate 200, and the pixel electrode 38a and the like are formed in each of a plurality of regions that is split as the second substrate 30 in the second mother substrate 300. Next, the first mother substrate 200 and the second mother substrate 300 are bonded to each other by the seal material 60. At this point, the seal material 60 is formed in a frame shape that is continuous on the periphery thereof, and the optoelectronic layer 50 is disposed in a region surrounded by the seal material 60. Accordingly, a first inner surface 200s that is a surface of the first mother substrate 200 facing the second mother substrate 300 corresponds to the first inner surface 20s of the first substrate 20, and a first outer surface 200t that is a surface on the opposite side of the first mother substrate 200 from the second mother substrate 300 corresponds to the first outer surface 20t of the first substrate 20. In addition, a second inner surface 300s that is a surface of the second mother substrate 300 facing the first mother substrate 200 corresponds to the second inner surface 30s of the second substrate 30, and a second outer surface 300t that is a surface on the opposite side of the second mother substrate 300 from the first mother substrate 200 corresponds to the second outer surface 30t of the second substrate 30.

Hereinafter, the composite substrate 400 will be split into a plurality of the optoelectronic devices 100 along exterior lines illustrated in FIG. 5, FIG. 6, and FIG. 7 (a first exterior line LX1, a second exterior line LX2, a third exterior line LX3, a fourth exterior line LY4, and a fifth exterior line LY5). The first exterior line LX1, the second exterior line LX2, the third exterior line LX3, the fourth exterior line LY4, and the fifth exterior line LY5 are planned split lines that are configured of imaginary lines defining the exteriors of the first substrate 20 and the second substrate 30 of the optoelectronic device 100. In the composite substrate 400, split regions of the optoelectronic devices 100 are adjacent in the Y direction and in the X direction. Accordingly, in the following description, two regions adjacent in the Y direction (a first region 400a and a second region 400b) will be mainly described.

In the present embodiment, the first exterior line LX1 is a planned cleaving line for the second mother substrate 300 and extends in the X direction along the periphery 61 of the seal material 60 disposed in each of the first region 400a and the second region 400b adjacent in the Y direction, the periphery 61 being positioned on the one side Y1 of the Y direction. The second exterior line LX2 is a planned cleaving line for the first mother substrate 200 and extends in the X direction along the periphery 61 of the seal material 60 disposed in each of the first region 400a and the second region 400b adjacent in the Y direction, the periphery 61 being positioned on the other side Y2 of the Y direction. The third exterior line LX3 is a planned cleaving line for the first mother substrate 200 and is a planned cleaving line that extends in the X direction along the periphery 61 of the seal material 60 disposed in each of the first region 400a and the second region 400b adjacent in the Y direction, the periphery 61 being positioned on the one side Y1 of Y. Accordingly, the first exterior line LX1 and the third exterior line LX3 overlap with each other in a plan view.

The fourth exterior line LY4 is a planned cleaving line for the second mother substrate 300 and extends in the Y direction along the periphery 61 of the seal material 60 disposed in each of the first region 400a and the second region 400b adjacent in the Y direction, the periphery 61 being positioned on both sides of the X direction. The fifth exterior line LY5 is a planned cleaving line for the first mother substrate 200 and extends in the Y direction along the periphery 61 of the seal material 60 disposed in each of the first region 400a and the second region 400b adjacent in the Y direction, the periphery 61 being positioned on both sides of the X direction. Accordingly, the fourth exterior line LY4 and the fifth exterior line LY5 overlap with each other in a plan view.

### Manufacturing Method for Optoelectronic Device 100

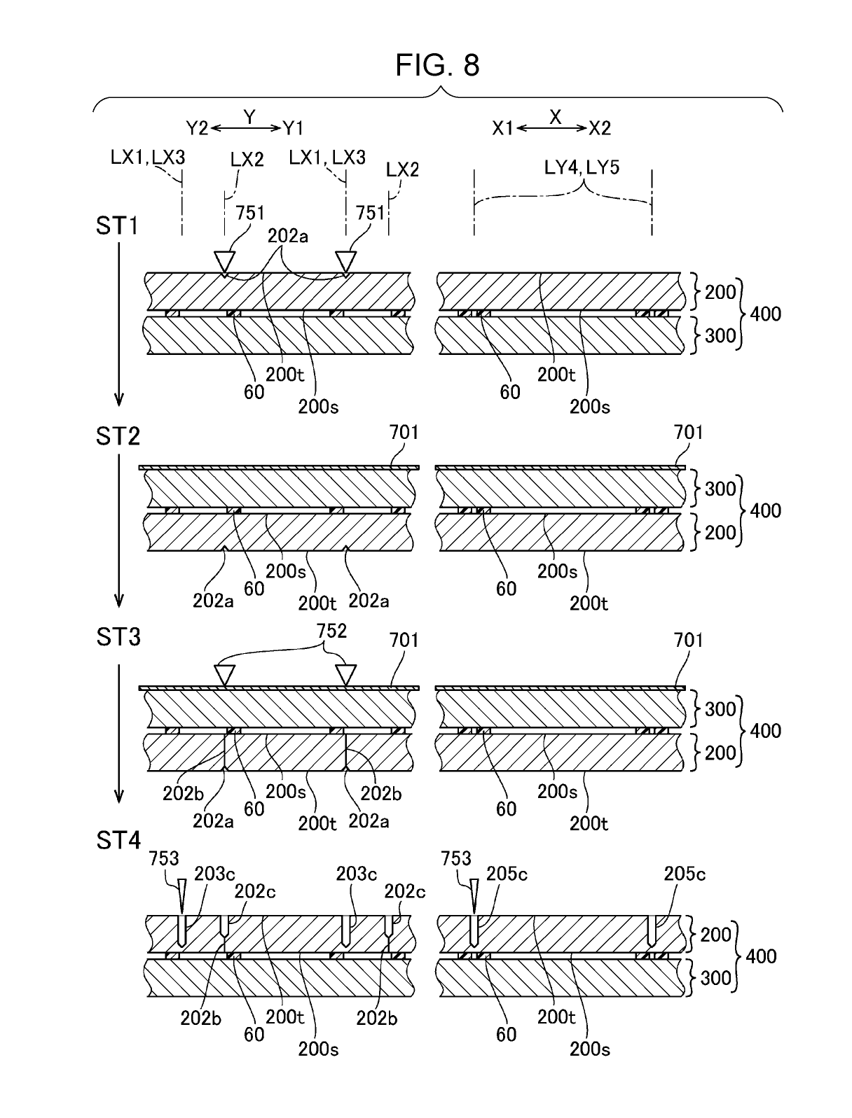

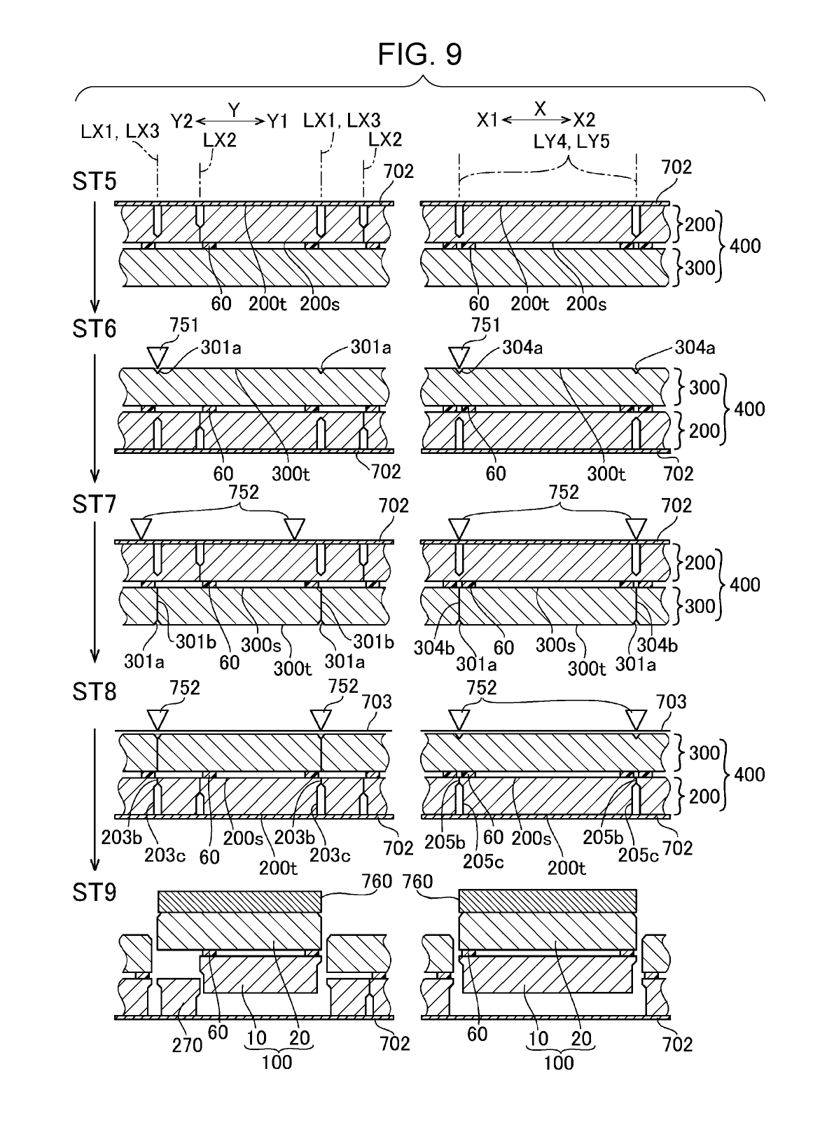

FIG. 8 and FIG. 9 are sectional step views illustrating a manufacturing method for the optoelectronic device 100 illustrated in FIG. 1. In FIG. 8 and FIG. 9, the Y0-Y0′ section is illustrated on the left side of the drawings, and the X0-X0′ section is illustrated on the right side of the drawings. In FIG. 8 and FIG. 9, the optoelectronic layer 50 and the like are not illustrated.

In the present embodiment, as described below with reference to FIG. 8 and FIG. 9, a dicing process of cleaving the first mother substrate 200 from the first outer surface 200t of the first mother substrate 200 to a midway position in the thickness direction and a first breaking process (a second cleaving step and a third cleaving step described later) of cleaving the first mother substrate 200 from the groove formed on the first outer surface 200t of the first mother substrate 200 are performed in a first splitting step of splitting the first mother substrate 200 along the periphery 61 of the seal material 60.

In addition, a second breaking process (first cleaving step described later) of cleaving the second mother substrate 300 from the groove formed on the second outer surface 300t of the second mother substrate 300 is performed in a second splitting step of splitting the second mother substrate 300 along the periphery 61 of the seal material 60.

More specifically, a breaking process (first breaking process) is performed for the first mother substrate 200 on the second exterior line LX2 in steps ST1, ST2, and ST3 illustrated in FIG. 8. At this point, in the step ST1 illustrated in FIG. 8, the first mother substrate 200 is turned upward, and a scribe groove 202a that extends along the second exterior line LX2 is formed on the first outer surface 200t of the first mother substrate 200 by a scribe head 751 that includes a diamond cutter or a cemented carbide cutter. Next, in the step ST2 illustrated in FIG. 8, the second mother substrate 300 is turned upward, and a first adhesive sheet 701 is bonded to the second outer surface 300t of the second mother substrate 300. Next, in the step ST3 illustrated in FIG. 8, the second mother substrate 300 is pressed by a breaking bar 752 through the first adhesive sheet 701. Consequently, load is exerted on the first mother substrate 200 to generate stress, and a cleaved surface 202b reaches the first inner surface 200s of the first mother substrate 200 from the scribe groove 202a. Accordingly, the first mother substrate 200 is cleaved along the second exterior line LX2 (second cleaving step).

Next, in the step ST4 illustrated in FIG. 8, a dicing process is performed for the first mother substrate 200 on the fifth exterior line LY5, the second exterior line LX2, and the third exterior line LX3. More specifically, first, in the step ST4 illustrated in FIG. 8, the first adhesive sheet 701 is removed, and then the first mother substrate 200 is turned upward, and a dicing process is performed for the first mother substrate 200 on the fifth exterior line LY5. At this point, on the fifth exterior line LY5, a dicing saw 753 is rendered to advance from the first outer surface 200t of the first mother substrate 200 to a midway position in the thickness direction, and a dicing groove 205c is formed in the first mother substrate 200 to the midway position in the thickness direction.

Next, on the second exterior line LX2, the dicing saw 753 is rendered to advance from the first outer surface 200t of the first mother substrate 200 to a midway position in the thickness direction, and a dicing groove 202c is formed in the first mother substrate 200 to the midway position in the thickness direction (a dicing process in the first splitting step).

Next, on the third exterior line LX3, the dicing saw 753 is rendered to advance from the first outer surface 200t of the first mother substrate 200 to a midway position in the thickness direction, and a dicing groove 203c is formed in the first mother substrate 200 to the midway position in the thickness direction (a dicing process in the first splitting step).

Next, in steps ST5, ST6, and ST7 illustrated in FIG. 9, a breaking process is performed for the second mother substrate 300 on the first exterior line LX1 and the fourth exterior line LY4 (the second breaking process in the second splitting step). More specifically, first, in the step ST5 illustrated in FIG. 9, the first mother substrate 200 is turned upward, and a second adhesive sheet 702 is bonded to the first outer surface 200t of the first mother substrate 200. Next, in the step ST6 illustrated in FIG. 9, the second mother substrate 300 is turned upward, and a scribe groove 301a that extends along the first exterior line LX1 is formed on the second outer surface 300t of the second mother substrate 300 by the scribe head 751.

In addition, a scribe groove 304a that extends along the fourth exterior line LY4 is formed on the second outer surface 300t of the second mother substrate 300 by the scribe head 751.

Next, in the step ST7 illustrated in FIG. 9, the first mother substrate 200 is turned upward, and the first mother substrate 200 is pressed by the breaking bar 752 through the second adhesive sheet 702. Consequently, load is exerted on the second mother substrate 300 to generate stress, and a cleaved surface 301b reaches the second inner surface 300s of the second mother substrate 300 from the scribe groove 301a. Accordingly, the second mother substrate 300 is cleaved along the first exterior line LX1 (first cleaving step).

In addition, when the first mother substrate 200 is pressed by the breaking bar 752 through the second adhesive sheet 702, load is exerted on the second mother substrate 300 to generate stress, and a cleaved surface 304b reaches the second inner surface 300s of the second mother substrate 300 from the scribe groove 304a. Accordingly, the second mother substrate 300 is split along the fourth exterior line LY4.

Next, in the step ST8 illustrated in FIG. 9, a breaking process (the first breaking process in the first splitting step) is performed for the first mother substrate 200 on the fifth exterior line LY5 and the third exterior line LX3. More specifically, first, in a breaking process performed for the first mother substrate 200 on the fifth exterior line LY5 in the step ST8 illustrated in FIG. 9, the second mother substrate 300 is turned upward, and the second mother substrate 300 is pressed through a protective sheet 703. Consequently, load is exerted on the first mother substrate 200 to generate stress, and a cleaved surface 205b reaches the first inner surface 200s of the first mother substrate 200 from the dicing groove 205c. Accordingly, the first mother substrate 200 is split along the fifth exterior line LY5.

In addition, in a breaking process performed for the first mother substrate 200 on the third exterior line LX3, the second mother substrate 300 is turned upward, and the second mother substrate 300 is pressed through the protective sheet 703. Consequently, load is exerted on the first mother substrate 200 to generate stress, and a cleaved surface 203b reaches the first inner surface 200s of the first mother substrate 200 from the dicing groove 203c. Accordingly, the first mother substrate 200 is cleaved along the third exterior line LX3 (third cleaving step).

Consequently, each of the first region 400a and the second region 400b is separated as the optoelectronic device 100 from the composite substrate 400. Accordingly, each of the first region 400a and the second region 400b is peeled and collected as the optoelectronic device 100 from the composite substrate 400 by a suction chuck 760. At this point, since the second adhesive sheet 702 is bonded to the first outer surface 200t of the first mother substrate 200 in the composite substrate 400, a split piece 270 that is split by the second exterior line LX2, the third exterior line LX3, and the fifth exterior line LY5 in the first mother substrate 200 remains on the adhesive sheet 702.

In the optoelectronic device 100 configured as above, the second side surfaces 30e and 30f of the second substrate 30 are formed by a part corresponding to the first exterior line LX1, and the second side surfaces 30g and 30h of the second substrate 30 are formed by a part corresponding to the fourth exterior line LY4.

In addition, the first side surface 20e of the first substrate 20 is formed by a part corresponding to the second exterior line LX2. The first side surface 20f of the first substrate 20 is formed by a part corresponding to the third exterior line LX3. The first side surfaces 20g and 20h of the first substrate 20 are formed by a part corresponding to the fifth exterior line LY5.

### Main Effect of Present Embodiment

As described heretofore, in the present embodiment, a dicing process is performed in the first splitting step of splitting the first mother substrate 200 along the periphery 61 of the seal material 60. Thus, the first side surfaces 20e, 20f, 20g, and 20h that have appropriate shapes, angles formed with the first outer surface 20t, and the like can be acquired in the first substrate 20 after the first mother substrate 200 is split. Therefore, the optoelectronic device 100, when being mounted on an electronic apparatus, can be positioned with high accuracy by using the exterior of the first substrate 20 as a reference.

In this case as well, a dicing process is performed to a midway position in the thickness direction, and the remaining part is split by a breaking process (first breaking process). Accordingly, the dicing saw 753 advances shallowly at the time of the dicing process, and thus what is unlikely to occur is that vibration of the dicing saw 753 affects and damages the seal material 60 or a film formed near the seal material 60. In addition, since a breaking process (second breaking process) is used even in the second splitting step of splitting the second mother substrate 300 along the periphery 61 of the seal material 60, what is unlikely to occur is that vibration of the dicing saw 753 at the time of the dicing process damages the seal material 60 or a film formed near the seal material 60. Therefore, since damage to a seal portion such as the seal material 60 or a film formed near the seal material 60 can be prevented, invasion of moisture, leaking of the optoelectronic layer 50, and the like are unlikely to occur.

In a manufacturing step such as the first splitting step or the second splitting step, pressure is likely to be exerted from the liquid-phase optoelectronic layer 50 on a seal portion such as the seal material 60 or a film formed near the seal material 60, particularly in the case of using ODF when the optoelectronic layer 50 is disposed. However, according to the present embodiment, damage to a seal portion can be prevented. Thus, even if pressure is exerted on the seal portion from the liquid-phase optoelectronic layer 50 when the first splitting step or the second splitting step is performed, damage to the seal portion can be prevented. Therefore, invasion of moisture to the optoelectronic layer 50 through the seal portion or leaking of the optoelectronic layer 50 is unlikely to occur.

A thick film is formed near the seal material 60 as the lens layer 241 is formed in the first substrate 20. Thus, damage to the film near the seal material 60 is likely to occur when a dicing process is performed. However, according to the present embodiment, great vibrations are not exerted on the film near the seal material 60 at the time of a dicing process. Thus, even if a thick film exists near the seal material 60, damage to the film near the seal material 60 can be prevented. Therefore, invasion of moisture to the optoelectronic layer 50 through the seal portion or leaking of the optoelectronic layer 50 is unlikely to occur.

When the optoelectronic device 100 is collected from the composite substrate 400, the split piece 270 produced in the first mother substrate 200 can be rendered to remain on the second adhesive sheet 702. Therefore, an advantage that the split piece 270 is not scattered is achieved.

The first cleaving step (step ST7), after the second cleaving step (step ST3) is performed, is performed in a state where the second adhesive sheet 702 is bonded to the first outer surface 200t of the first mother substrate 200, and then the third cleaving step (ST8) is performed. Thus, the second adhesive sheet 702 used in the first cleaving step (step ST7) can hold the split piece 270 in the third cleaving step (ST8).

A dicing process is performed along the third exterior line LX3 before the first cleaving step (step ST7). After the first cleaving step (step ST7), a breaking process is performed from the dicing groove 203c in the third cleaving step (step ST8). Thus, since dicing processes can be collectively performed for the first mother substrate 200 before the first cleaving step (ST7), the efficiency of production can be improved.

### Example of Mounting on Electronic Apparatus

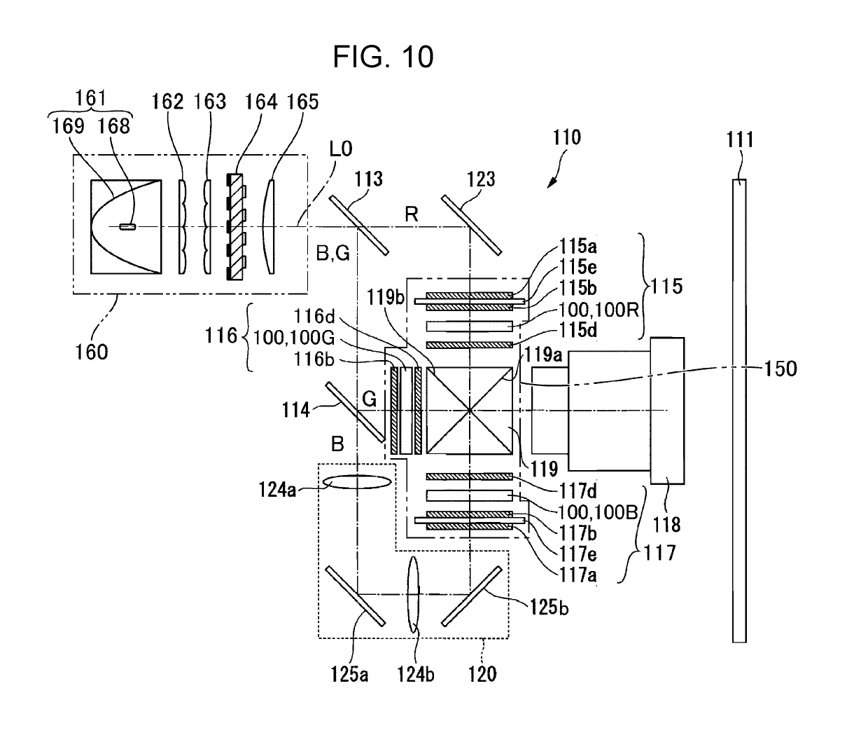

FIG. 10 is a schematic configuration diagram of a projection display apparatus (electronic apparatus) in which the optoelectronic device 100 to which the invention is applied is used. In the following description, a plurality of the optoelectronic devices 100 that is supplied with light in different wavelength regions is used. For any of the optoelectronic devices 100, the optoelectronic device 100 to which the invention is applied is used.

A projection display apparatus 110 illustrated in FIG. 10 is a liquid crystal projector in which the transmissive optoelectronic device 100 is used, and irradiates a projection member 111 configured of a screen or the like with light to display an image. The projection display apparatus 110 has, along an apparatus optical axis L0, an illumination device 160, a plurality of the optoelectronic devices 100 (liquid crystal light valves 115 to 117) that is supplied with light emitted from the illumination device 160, a cross dichroic prism 119 (light composition optical system) that combines and emits light emitted from the plurality of optoelectronic devices 100, and a projection optical system 118 that projects light combined by the cross dichroic prism 119. In addition, the projection display apparatus 110 includes dichroic mirrors 113 and 114 and a relay system 120. In the projection display apparatus 110, the optoelectronic device 100 and the cross dichroic prism 119 constitute an optical unit 150.

An illuminant unit 161, a first integrator lens 162 that is configured of a lens array such as a fly's eye lens, a second integrator lens 163 that is configured of a lens array such as a fly's eye lens, a polarization conversion element 164, and a condenser lens 165 are arranged in the illumination device 160 in this order along the apparatus optical axis L0. The illuminant unit 161 includes an illuminant 168 and a reflector 169. The illuminant 168 emits white light that includes red light R, green light G, and blue light B. The illuminant 168 is configured of an extra-high-pressure mercury lamp, and the reflector 169 has a section of a parabolic shape. The first integrator lens 162 and the second integrator lens 163 render the illuminance distribution of light emitted from the illuminant unit 161 uniform. The polarization conversion element 164 turns the light emitted from the illuminant unit 161 into polarized light that has a specific direction of vibration such as s polarized light.

The dichroic mirror 113 transmits the red light R included in the light emitted from the illumination device 160 and reflects the green light G and the blue light B. The dichroic mirror 114, for the green light G and the blue light B reflected by the dichroic mirror 113, transmits the blue light B and reflects the green light G. The dichroic mirrors 113 and 114 constitute a color separation optical system that separates the light emitted from the illumination device 160 into the red light R, the green light G, and the blue light B.

The liquid crystal light valve 115 is a transmissive liquid crystal device that, according to an image signal, modulates the red light R which is transmitted by the dichroic mirror 113 and reflected by a reflective mirror 123. The liquid crystal light valve 115 includes λ/2 retarder plate 115a, a first polarization plate 115b, the optoelectronic device 100 (red optoelectronic device 100R), and a second polarization plate 115d. The red light R that is incident on the liquid crystal light valve 115 does not have the polarization thereof changed even if transmitted through the dichroic mirror 113, and thus remains as s polarized light.

The λ/2 retarder plate 115a is an optical element that converts the s polarized light incident on the liquid crystal light valve 115 into p polarized light. The first polarization plate 115b is a polarization plate that blocks s polarized light and transmits p polarized light. The optoelectronic device 100 (red optoelectronic device 100R) is configured to convert p polarized light into s polarized light (circularly polarized light or elliptically polarized light in the case of halftone) by modulating p polarized light according to an image signal. The second polarization plate 115d is a polarization plate that blocks p polarized light and transmits s polarized light. Accordingly, the liquid crystal light valve 115 modulates the red light R according to an image signal and emits the modulated red light R toward the cross dichroic prism 119. The λ/2 retarder plate 115a and the first polarization plate 115b are arranged in a state of contact with a light-transmissive glass plate 115e that does not convert polarized light, and distortion of the λ/2 retarder plate 115a and the first polarization plate 115b by heat generation can be avoided.

The liquid crystal light valve 116 is a transmissive liquid crystal device that, according to an image signal, modulates the green light G which is reflected by the dichroic mirror 113 and then reflected by the dichroic mirror 114. The liquid crystal light valve 116, in the same manner as the liquid crystal light valve 115, includes a first polarization plate 116b, the optoelectronic device 100 (green optoelectronic device 100G), and a second polarization plate 116d. The green light G that is incident on the liquid crystal light valve 116 is s polarized light that is incident after reflected by the dichroic mirrors 113 and 114. The first polarization plate 116b is a polarization plate that blocks p polarized light and transmits s polarized light. The optoelectronic device 100 (green optoelectronic device 100G) is configured to convert s polarized light into p polarized light (circularly polarized light or elliptically polarized light in the case of halftone) by modulating s polarized light according to an image signal. The second polarization plate 116d is a polarization plate that blocks s polarized light and transmits p polarized light. Accordingly, the liquid crystal light valve 116 modulates the green light G according to an image signal and emits the modulated green light G toward the cross dichroic prism 119.

The liquid crystal light valve 117 is a transmissive liquid crystal device that, according to an image signal, modulates the blue light B which is reflected by the dichroic mirror 113 and transmitted by the dichroic mirror 114 and then passes through the relay system 120. The liquid crystal light valve 117, in the same manner as the liquid crystal light valves 115 and 116, includes a λ/2 retarder plate 117a, a first polarization plate 117b, the optoelectronic device 100 (blue optoelectronic device 100B), and a second polarization plate 117d. The blue light B that is incident on the liquid crystal light valve 117 is reflected by the dichroic mirror 113, transmitted by the dichroic mirror 114, and then reflected by two reflective mirrors 125a and 125b of the relay system 120, and thus is s polarized light.

The λ/2 retarder plate 117a is an optical element that converts the s polarized light incident on the liquid crystal light valve 117 into p polarized light. The first polarization plate 117b is a polarization plate that blocks s polarized light and transmits p polarized light. The optoelectronic device 100 (blue optoelectronic device 100B) is configured to convert p polarized light into s polarized light (circularly polarized light or elliptically polarized light in the case of halftone) by modulating p polarized light according to an image signal. The second polarization plate 117d is a polarization plate that blocks p polarized light and transmits s polarized light. Accordingly, the liquid crystal light valve 117 modulates the blue light B according to an image signal and emits the modulated blue light B toward the cross dichroic prism 119. The λ/2 retarder plate 117a and the first polarization plate 117b are arranged in a state of contact with a glass plate 117e.

The relay system 120 includes relay lenses 124a and 124b and the reflective mirrors 125a and 125b. The relay lenses 124a and 124b are disposed in order to prevent loss of light due to a long optical path for the blue light B. The relay lens 124a is arranged between the dichroic mirror 114 and the reflective mirror 125a. The relay lens 124b is arranged between the reflective mirrors 125a and 125b. The reflective mirror 125a reflects, toward the relay lens 124b, the blue light B which is transmitted by the dichroic mirror 114 and emitted from the relay lens 124a. The reflective mirror 125b reflects, toward the liquid crystal light valve 117, the blue light B which is emitted from the relay lens 124b.

The cross dichroic prism 119 is a color composition optical system in which two dichroic films 119a and 119b are orthogonally arranged in an X shape. The dichroic film 119a is a film that reflects the blue light B and transmits the green light G, and the dichroic film 119b is a film that reflects the red light R and transmits the green light G. Accordingly, the cross dichroic prism 119 combines the red light R, the green light G, and the blue light B which are respectively modulated by the liquid crystal light valves 115 to 117, and emits the combined light toward the projection optical system 118.

Light that is incident on the cross dichroic prism 119 from the liquid crystal light valves 115 and 117 is s polarized light, and light that is incident on the cross dichroic prism 119 from the liquid crystal light valve 116 is p polarized light. By rendering the light incident on the cross dichroic prism 119 to be different types of polarized light, light that is incident on the cross dichroic prism 119 from each of the liquid crystal light valves 115 to 117 can be combined. Generally, the dichroic films 119a and 119b have excellent reflection characteristics for s polarized light. Thus, the red light R and the blue light B that are reflected by the dichroic films 119a and 119b are set to be s polarized light, and the green light G that is transmitted by the dichroic films 119a and 119b is set to be p polarized light. The projection optical system 118 has a projection lens (not illustrated) and projects the light combined by the cross dichroic prism 119 to the projection member 111 such as a screen.

### Other Projection Display Apparatuses

The above projection display apparatus may be configured in such a manner that LED illuminants and the like emitting light of each color are used as the illuminant unit and that each color light emitted from such LED illuminants is supplied to another liquid crystal device.

The optoelectronic device 100 to which the invention is applied may be used for, in addition to the above electronic apparatus, a projection head-up display (HUD), a direct view head-mounted display (HMD), a mobile phone, a mobile information terminal (personal digital assistants (PDA)), a digital camera, a liquid crystal television, a car navigation apparatus, a television phone, and the like.

### Second Embodiment

A liquid crystal device which is a representative optoelectronic device will be described as a second embodiment of the invention. In the drawings referred to in the following description, different scales are used for each layer or for each member in order for each layer or each member to have a size recognizable on the drawings.

### Configuration of Optoelectronic Device

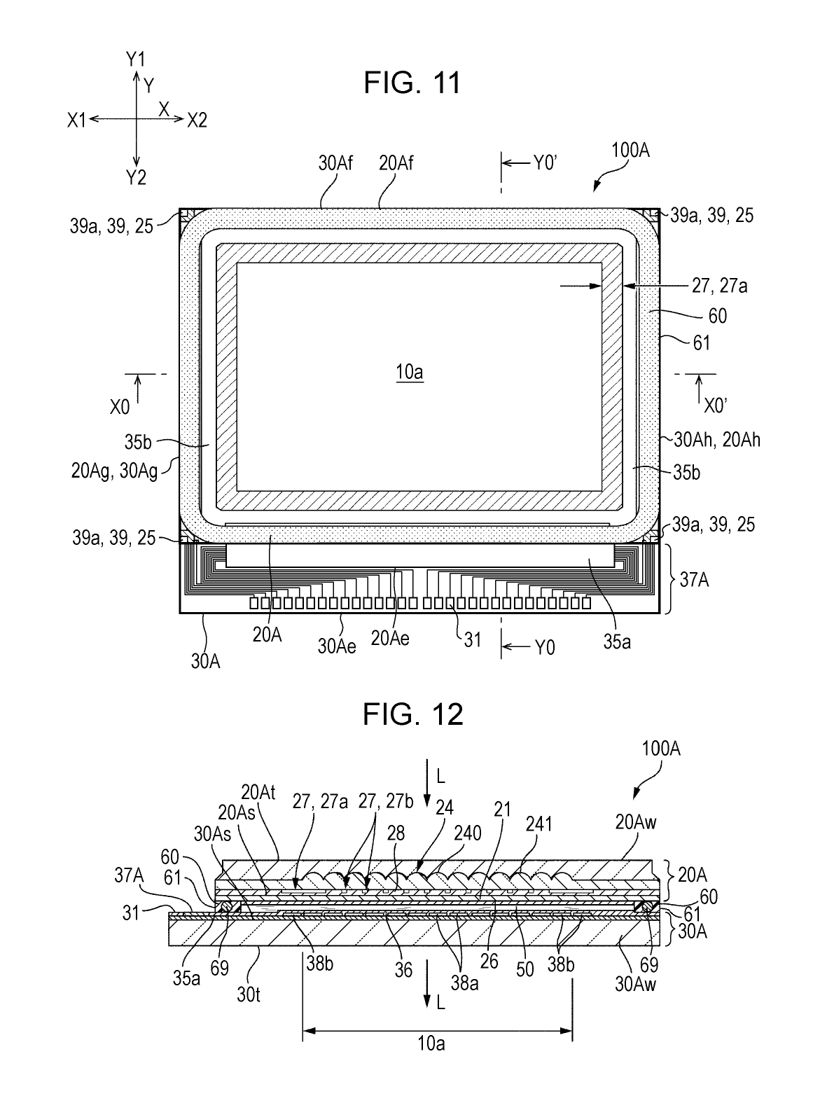

FIG. 11 is a plan view when an optoelectronic device 100A to which the invention is applied is seen from the first substrate 20A side thereof, and FIG. 12 is a Y0-Y0′ sectional view of the optoelectronic device illustrated in FIG. 11. In the following description, a Y direction corresponds to a “first direction” in the invention, and an X direction corresponds to a “second direction” in the invention. In addition, one side of the Y direction (one side of the first direction) will be assigned Y2, and the other side of the Y direction (the other side of the first direction) will be assigned Y1. One side of the X direction (one side of the second direction) will be assigned X2, and the other side of the X direction (the other side of the second direction) will be assigned X1.

The optoelectronic device 100A illustrated in FIG. 11 and FIG. 12 is a liquid crystal device in which a first substrate 20A (opposite substrate) and a second substrate 30A (element substrate) are bonded to each other by the seal material 60 extending along the periphery of the first substrate 20A. The seal material 60 is configured of an adhesive such as light-curable resin, thermosetting resin, or anaerobic curable resin. In the optoelectronic device 100A, the liquid-phase optoelectronic layer 50 that is configured of a liquid crystal material is disposed within a region surrounded by the seal material 60 between the first substrate 20A and the second substrate 30A, and the seal material 60 bonds the first substrate 20A and the second substrate 30A to each other and seals the optoelectronic layer 50. The seal material 60 contains the gapping material 69, and the gapping material 69 controls the gap between the first substrate 20A and the second substrate 30A (the thickness of the optoelectronic layer 50). In the present embodiment, a liquid crystal drop injection method (one drop fill (ODF) method) is used in disposing of the optoelectronic layer 50. In such a method, for example, the seal material 60 is disposed in a frame shape on a side of the second substrate 30A, after which a liquid-phase optoelectronic material is dropped on the inner side of the seal material 60, and then the first substrate 20A and the second substrate 30A are bonded to each other. Thus, the seal material 60 is continuous on the entire periphery. The first substrate 20A may be bonded to the second substrate 30A in a state where a part of the seal material 60 is disconnected, and then a liquid-phase optoelectronic material may be injected in a vacuum from the disconnected part of the seal material 60. In this case, the disconnected part of the seal material 60 is filled with a sealant.

In the optoelectronic device 100A, a substrate main body 20Aw of the first substrate 20A and a substrate main body 30Aw of the second substrate 30A are light-transmissive substrates such as glass or quartz substrates. In addition, either of the first substrate 20A (substrate main body 20Aw) and the second substrate 30A (substrate main body 30Aw) has a thickness of approximately less than 1 mm. In addition, the first substrate 20A (substrate main body 20Aw) and the second substrate 30A (substrate main body 30Aw) have a quadrangular shape in a plane (XY plane) and have side surfaces on four edges thereof. Given that a side surface of the first substrate 20A is a first side surface, the first substrate 20A includes two facing first side surfaces 20Ae and 20Af in the Y direction and two facing first side surfaces 20Ag and 20Ah in the X direction. In addition, given that a side surface of the second substrate 30A is a second side surface, the second substrate 30A includes two facing second side surfaces 30Ae and 30Af in the Y direction and two facing second side surfaces 30Ag and 30Ah in the X direction. The display region 10a is disposed as a quadrangular region in an approximate center of the optoelectronic device 100A.

In the optoelectronic device 100A, the first substrate 20A is smaller than the second substrate 30A, and the seal material 60 and the second substrate 30A are disposed in a position shifted to the other side Y1 of the Y direction in the first substrate 20A. Thus, the second substrate 30A has an extending portion 37A that extends from the first substrate 20A. Specifically, the second substrate 30A extends from the first side surface 20Ae of the first substrate 20A and has the extending portion 37A between the second side surface 30Ae of the second substrate 30A and the first side surface 20Ae of the first substrate 20A. Meanwhile, both of the first side surface 20Af and the second side surface 30Af overlap with the periphery 61 of the seal material 60 in a plan view on the other side Y1 of the Y direction. Either of the first side surface 20Ag and the second side surface 30Ag overlaps with the periphery 61 of the seal material 60 in a plan view on the other side X1 of the X direction. In addition, either of the first side surface 20Ah and the second side surface 30Ah overlaps with the periphery 61 of the seal material 60 in a plan view on the one side X2 of the X direction.

In the second substrate 30A, the data line drive circuit 35a and a plurality of the terminals 31 are formed in a region outside of the display region 10a on the one side Y2 of the Y direction, and the terminal 31 is arranged along the second side surface 30Ae in the extending portion 37A. In addition, the scan line drive circuit 35b is formed in the second substrate 30A along each of the second side surfaces 30Ag and 30Ah. A flexible interconnect substrate (not illustrated) is connected to the terminal 31, and through the flexible interconnect substrate, various electrical potentials or various signals are input from an external control circuit to the second substrate 30A.

The first substrate 20A has a first inner surface 20As that is a surface on the second substrate 30A side thereof, and a first outer surface 20At that is a surface on the opposite side thereof from the second substrate 30A side. The common electrode 21 is formed on the first inner surface 20As.

The second substrate 30A has a second inner surface 30As that is a surface on the first substrate 20A side thereof, and a second outer surface 30At that is a surface on the opposite side thereof from the second substrate 30A side. On the second inner surface 30As side of the second substrate 30A, the pixel electrode 38a, a pixel transistor (not illustrated), and the like are arranged in a matrix in the display region 10a. The dummy pixel electrode 38b that is formed at the same time as the pixel electrode 38a is formed in a region surrounded by the display region 10a and the first side surfaces 20Ae, 20Af, 20Ag, and 20Ah of the first substrate 20A on the second inner surface 30As of the second substrate 30A. The dummy pixel electrode 38b to which a common electrical potential Vcom is applied prevents orientation of liquid crystal molecules from being disturbed in a peripheral side end portion of the display region 10a. An oriented film 36 is formed as a layer above the pixel electrode 38a and the dummy pixel electrode 38b.

In the first substrate 20A, the common electrode 21 is formed on an approximately entire surface of the display region 10a or across a plurality of pixels as a plurality of band-shaped electrodes. In the present embodiment, the common electrode 21 is formed on the entire surface of a rectangular region that includes the display region 10a. On the first inner surface 20As of the first substrate 20A, the protective film 28 and the light blocking layer 27 are formed below the common electrode 21, and the oriented film 26 is stacked on the surface of the common electrode 21. The light blocking layer 27 is formed as a frame part 27a that extends along the periphery of the display region 10a, and the inner periphery of the light blocking layer 27 defines the display region 10a. In addition, the light blocking layer 27 is formed as a black matrix portion 27b that overlaps with an inter-pixel region surrounded by the adjacent pixel electrodes 38a.

The inter-substrate conduction electrode 25 is formed near four corners of the first inner surface 20As of the first substrate 20A, and the inter-substrate conduction electrode 39 is formed in a position facing the inter-substrate conduction electrode 25 of the first substrate 20A on the second inner surface 30As of the second substrate 30A. In the present embodiment, the inter-substrate conduction electrode 25 is configured of a part of the common electrode 21. The inter-substrate conductive material 39a that includes conductive particles such as silver is arranged between the inter-substrate conduction electrode 39 and the inter-substrate conduction electrode 25, and the common electrode 21 of the first substrate 20A is electrically connected to the second substrate 30A side through the inter-substrate conduction electrode 39, the inter-substrate conductive material 39a, and the inter-substrate conduction electrode 25. Thus, the common electrical potential Vcom is applied from the second substrate 30A side to the common electrode 21.

### Configuration of Lens 24

The first substrate 20A is configured as a lens array substrate in which a plurality of the lenses 24 that overlaps in a one-to-one relationship with each of a plurality of the pixel electrodes 38a in a plan view (a state where the first substrate 20A is seen from a direction perpendicular to the XY plane), and the lens 24 has a function of effectively guiding light to an opening region of the second substrate 30A. In the present embodiment, the lens surface 240 that is configured of a rough surface or a convex surface is formed in the substrate main body 20Aw, and the lens layer 241 is stacked on the lens surface 240. In the present embodiment, the lens surface 240 is configured of a concave surface. In addition, the lens layer 241 has a greater refractive index than the substrate main body 20Aw. Thus, the lens surface 240 functions as the lens 24 that has positive power.

In the present embodiment, the optoelectronic device 100A is a transmissive liquid crystal device, and the pixel electrode 38a and the common electrode 21 are formed of light-transmissive conductive films such as an indium tin oxide (ITO) film and an indium zinc oxide (IZO) film. In such a transmissive liquid crystal display (optoelectronic device 100A), for example, light that is incident from the first outer surface 20At of the first substrate 20A is modulated while being emitted from the second substrate 30A, as illustrated by the arrow L in FIG. 12, and thereby an image is displayed. In a case where the optoelectronic device 100A is a reflective liquid crystal device, the common electrode 21 is formed of a light-transmissive conductive film such as an ITO film or an IZO film, and the pixel electrode 38a is formed of a reflective conductive film such as an aluminum film. In such a reflective liquid crystal display (optoelectronic device 100A), light that is incident from the first outer surface 20At of the first substrate 20A is modulated while being emitted after reflected by the second substrate 30A, and thereby an image is displayed.

The optoelectronic device 100A can be used as a color display device for an electronic apparatus such as a mobile computer and a mobile phone. In this case, a color filter (not illustrated) is formed in the first substrate 20A. In addition, the optoelectronic device 100A can be used as electronic paper. In addition, in the optoelectronic device 100A, a polarization film, a retarder film, a polarization plate, and the like are arranged in a predetermined direction with respect to the optoelectronic device 100A according to the type of the optoelectronic layer 50 (liquid crystal material) used or a normally white mode/normally black mode. Furthermore, the optoelectronic device 100A can be used as an RGB light valve in a projection display apparatus (liquid crystal projector) described later. In this case, light of each color that is separated through an RGB color separation dichroic mirror is individually incident as projected light on each optoelectronic device 100A for RGB, and thus a color filter is not formed.

### Configuration of First Side Surfaces 20Ae to 20Ah of First Substrate 20A and Like

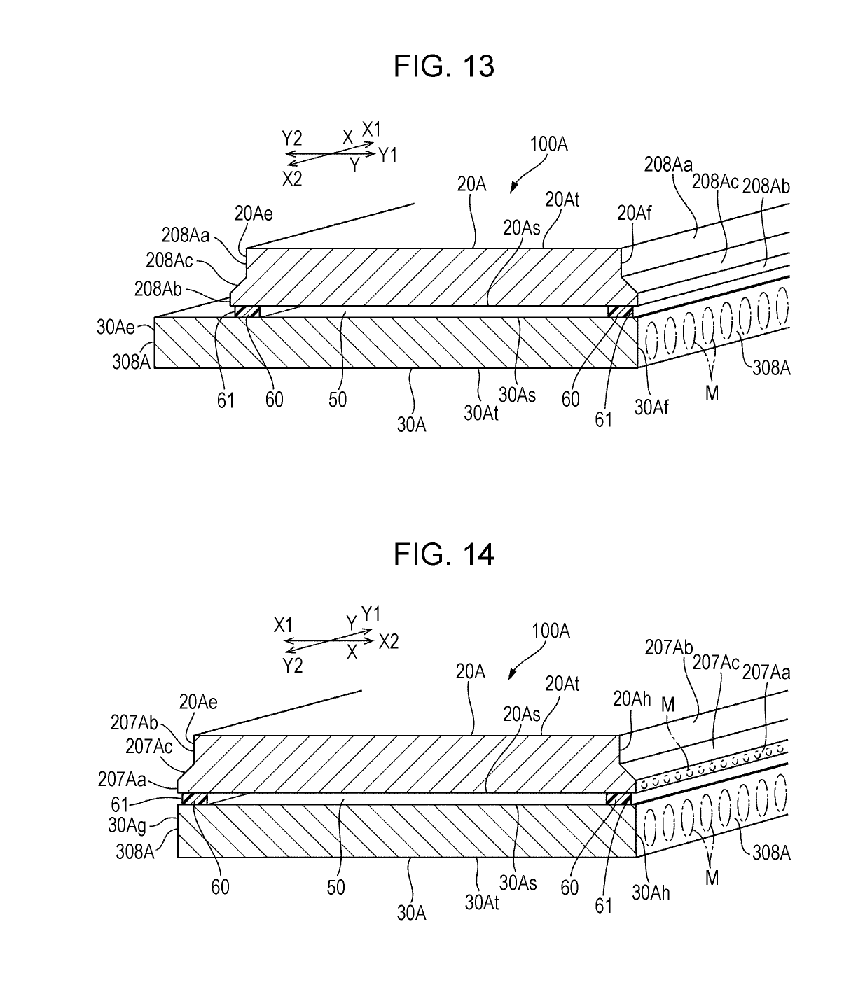

FIG. 13 is a descriptive diagram in which end portions on both sides in the Y direction of the optoelectronic device 100A illustrated in FIG. 11 are illustrated in an enlarged manner, and FIG. 13 corresponds to the Y0-Y0′ section. FIG. 14 is a descriptive diagram in which end portions on both sides in the X direction of the optoelectronic device 100A illustrated in FIG. 11 are illustrated in an enlarged manner, and FIG. 14 corresponds to an X0-X0′ section.

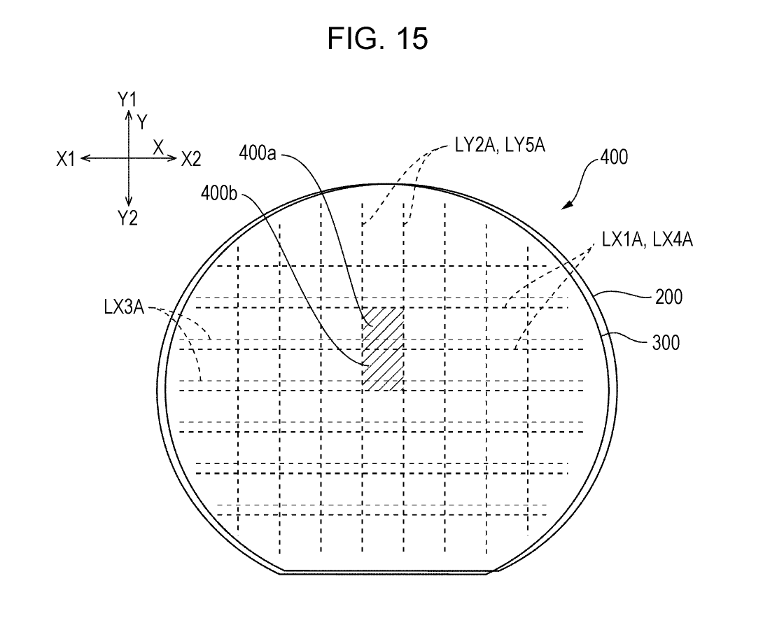

The optoelectronic device 100A of the present embodiment is manufactured by a method that is described later with reference to FIG. 15 to FIG. 19. Thus, the first side surfaces 20Ae, 20Af, 20Ag, and 20Ah of the first substrate 20A and the second side surfaces 30Ae, 30Af, 30Ag, and 30Ah of the second substrate 30A have the following configuration as illustrated in FIG. 13 and FIG. 14.

First, the first side surfaces 20Ae, 20Af, 20Ag, and 20Ah of the first substrate 20A extend along the periphery 61 of the seal material 60. Of the first side surfaces 20Ae, 20Af, 20Ag, and 20Ah, on either the first side surfaces 20Ae and 20Af positioned on both sides of the Y direction or the first side surfaces 20Ag and 20Ah positioned on both sides of the X direction, a first part 207Aa in which a spot-shaped thermally modified part M formed by laser scribing is distributed exists between the first inner surface 20As and a midway position in the thickness direction (a position midway from the first inner surface 20As toward the first outer surface 20At), and a second part 207Ab in which the thermally modified part M is not distributed exists between the midway position and the first outer surface 20At, and a step portion 207Ac is formed between the first part 207Aa and the second part 207Ab. In the present embodiment, the first part 207Aa, the second part 207Ab, and the step portion 207Ac exist on the first side surfaces 20Ag and 20Ah positioned on both sides of the X direction. The first part 207Aa is configured of a crack that is formed by laser scribing, and such a crack is generated by stress when the spot-shaped thermally modified part M is formed by heat from irradiation of a laser spot at the time of laser scribing. The second part 207Ab is a section formed by a dicing saw, and thus the thermally modified part M does not exist therein. In addition, the step portion 207Ac that is caused by the thickness of a dicing saw is formed between the first part 207Aa and the second part 207Ab, and the first part 207Aa protrudes to the opposite side of the second part 207Ab from the optoelectronic layer 50. Accordingly, the size of the first substrate 20A in the X direction in a position corresponding to the first part 207Aa is greater than the size thereof in the X direction in a position corresponding to the second part 207Ab. That is, the periphery of the first substrate 20A including the first part 207Aa has a greater planar size than the periphery of the first substrate 20A including the second part 207Ab.

Meanwhile, on the first side surfaces 20Ae and 20Af positioned on both sides of the Y direction, a third part 208Aa having fine roughness exists between the first outer surface 20At and a midway position in the thickness direction (a position midway from the first outer surface 20At toward the first inner surface 20As), and a fourth part 208Ab that has lower light-scattering ability than the third part 208Aa exists between the third part 208Aa and the first inner surface 20As, and a step portion 208Ac is formed between the third part 208Aa and the fourth part 208Ab. The third part 208Aa is a section formed by a dicing saw, and a mark of the dicing saw remains as fine roughness at the time of cleaving, and thus the third part 208Aa has high light-scattering ability. Meanwhile, the fourth part 208Ab is configured of a cleaved surface that starts from a groove formed on the first outer surface 20At in a breaking process and reaches the first inner surface 20As, and the fourth part 208Ab is an approximately specular surface. Thus, the fourth part 208Ab has lower light-scattering ability than the third part 208Aa. In addition, the step portion 208Ac that is caused by the thickness of a dicing saw is formed between the third part 208Aa and the fourth part 208Ab, and the fourth part 208Ab protrudes to the opposite side of the third part 208Aa from the optoelectronic layer 50. Accordingly, the size of the first substrate 20A in the Y direction in a position corresponding to the fourth part 208Ab is greater than the size thereof in the Y direction in a position corresponding to the third part 208Aa. That is, the periphery of the first substrate 20A including the fourth part 208Ab has a greater planar size than the periphery of the first substrate 20A including the third part 208Aa.

The thermally modified part M is distributed on the entirety from the second inner surface 30As to the second outer surface 30At on, of the second side surfaces 30Ae, 30Af, 30Ag, and 30Ah which are side surfaces of the second substrate 30A, either the second side surfaces 30Ae and 30Af positioned on both sides of the Y direction or the second side surfaces 30Ag and 30Ah positioned on both sides of the X direction. In the present embodiment, the entirety from the second inner surface 30As to the second outer surface 30At on all of the second side surfaces 30Ae, 30Af, 30Ag, and 30Ah is a surface 308A in which the thermally modified part M is distributed. That is, all of the second side surfaces 30Ae, 30Af, 30Ag, and 30Ah of the second substrates 30A are sections formed by laser scribing. Of the second side surfaces 30Ae, 30Af, 30Ag, and 30Ah, either a surface positioned on the other side Y1 of the Y direction or surfaces positioned on both sides of the second direction Y overlap with the first part 207Aa of the first substrate 20A in a plan view. In the present embodiment, the second side surfaces 30Ag and 30Ah positioned on both sides of the X direction (the one side X2 and the other side X1) in the second substrate 30A overlap with the first part 207Aa of the first substrate 20A in a plan view. In addition, the surface 30Af positioned on the other side Y1 of the Y direction in the second substrate 30A overlaps with the fourth part 208Ab of the first substrate 20A in a plan view.

### Configuration of Composite Substrate 400 and Exterior Line

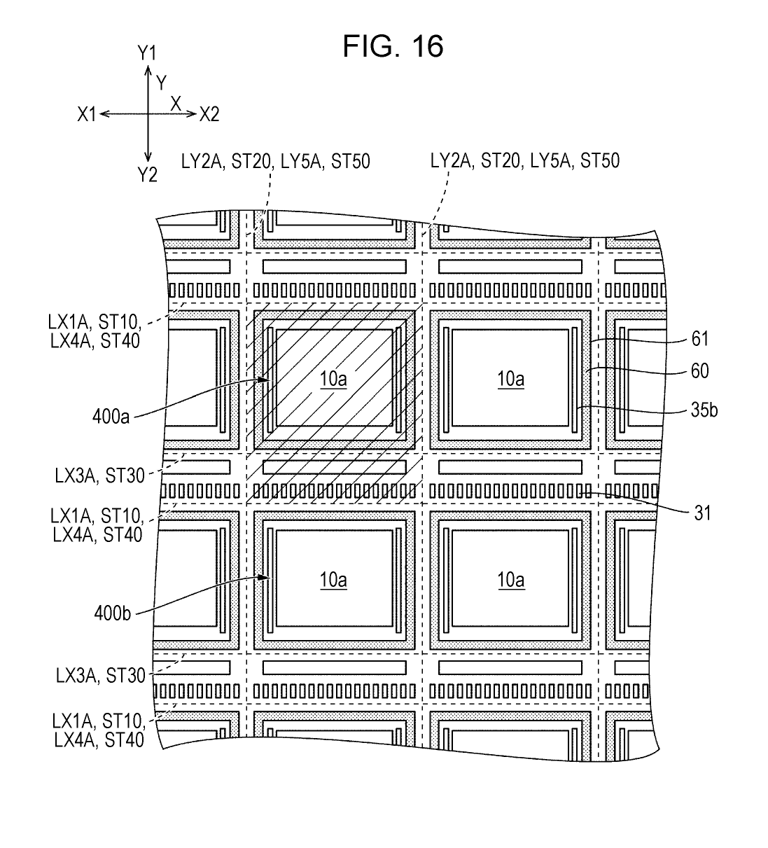

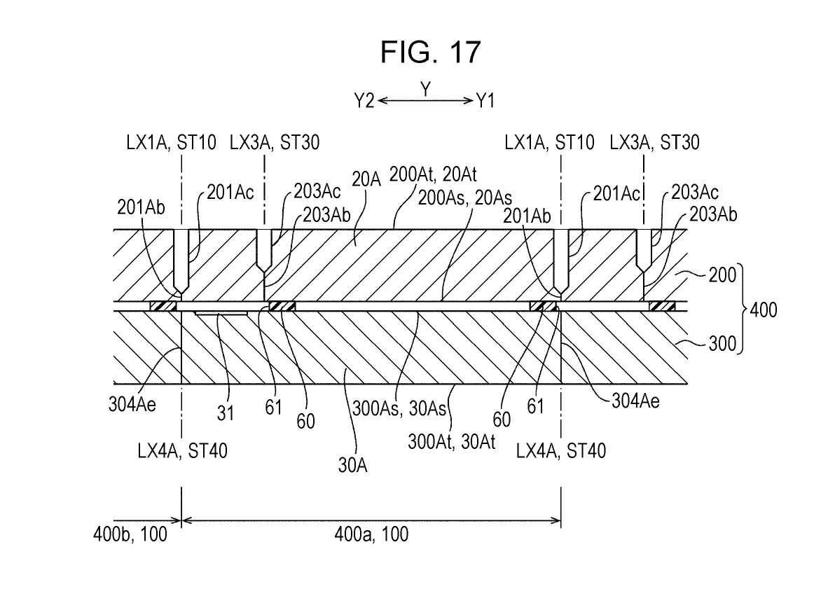

FIG. 15 is a plan view of the composite substrate 400 that is used in a manufacturing method for the optoelectronic device 100A illustrated in FIG. 11. The composite substrate 400 is configured of the first mother substrate 200 and the second mother substrate 300. FIG. 16 is a plan view in which a part of the composite substrate 400 illustrated in FIG. 15 is illustrated in an enlarged manner. FIG. 17 is a sectional view in which a part of the composite substrate 400 illustrated in FIG. 15 is illustrated in an enlarged manner, and FIG. 17 corresponds to a sectional view taken along the line Y0-Y0′ illustrated in FIG. 11 and the like. In FIG. 15, in order to easily recognize the first mother substrate 200 and the second mother substrate 300, each end portion thereof is illustrated as being shifted from each other. In addition, in FIG. 16, in order to easily recognize the exterior line, the exterior line and the seal material 60 are illustrated as being separated from each other more than in reality.

In manufacturing steps for the optoelectronic device 100A described with reference to FIG. 11 and the like, the first mother substrate 200 from which the first substrate 20A can be acquired in multiple numbers and the second mother substrate 300 from which the second substrate 30A can be acquired in multiple numbers are prepared as illustrated in FIG. 15. Next, the common electrode 21 and the like are formed in each of a plurality of regions that is split as the first substrate 20A in the first mother substrate 200, and the pixel electrode 38a and the like are formed in each of a plurality of regions that is split as the second substrate 30A in the second mother substrate 300. Next, the first mother substrate 200 and the second mother substrate 300 are bonded to each other by the seal material 60. At this point, the seal material 60 is formed in a frame shape that is continuous on the periphery thereof, and the optoelectronic layer 50 is disposed in a region surrounded by the seal material 60. Accordingly, a first inner surface 200As that is a surface of the first mother substrate 200 facing the second mother substrate 300 corresponds to the first inner surface 20As of the first substrate 20A, and the first outer surface 200At that is a surface on the opposite side of the first mother substrate 200 from the second mother substrate 300 corresponds to the first outer surface 20At of the first substrate 20A. In addition, a second inner surface 300As that is a surface of the second mother substrate 300 facing the first mother substrate 200 corresponds to the second inner surface 30As of the second substrate 30A, and a second outer surface 300At that is a surface on the opposite side of the second mother substrate 300 from the first mother substrate 200 corresponds to the second outer surface 30At of the second substrate 30A.

Hereinafter, the composite substrate 400 will be split into a plurality of the optoelectronic devices 100A along exterior lines illustrated in FIG. 15, FIG. 16, and FIG. 17 (a first exterior line LX1A, a second exterior line LY2A, a third exterior line LX3A, a fourth exterior line LX4A, and a fifth exterior line LY5A). The first exterior line LX1A, the second exterior line LY2A, the third exterior line LX3A, the fourth exterior line LX4A, and the fifth exterior line LY5A are planned split lines that are configured of imaginary lines defining the exteriors of the first substrate 20A and the second substrate 30A of the optoelectronic device 100A. In the composite substrate 400, split regions of the optoelectronic devices 100A are adjacent in the Y direction and in the X direction. Accordingly, in the following description, two regions adjacent in the Y direction (the first region 400a and the second region 400b) will be mainly described.

In the present embodiment, the first exterior line LX1A is a planned cleaving line for the first mother substrate 200 and extends in the X direction along the periphery 61 of the seal material 60 positioned on both sides of the Y direction. The second exterior line LY2A is a planned cleaving line for the first mother substrate 200 and extends in the Y direction along the periphery 61 of the seal material 60 positioned on both sides of the X direction. The third exterior line LX3A is a planned cleaving line for the first mother substrate 200 and extends on the one side Y2 of the Y direction with respect to the seal material 60 between the first exterior line LX1A and the seal material 60 in the X direction along the periphery 61 of the seal material 60 positioned on the one side Y2 of the Y direction.

The fourth exterior line LX4A is a planned cleaving line for the second mother substrate 300 and extends in the X direction along the periphery 61 of the seal material 60 positioned on both sides of the Y direction. The fifth exterior line LY5A is a planned cleaving line for the second mother substrate 300 and extends in the Y direction along the periphery 61 of the seal material 60 positioned on both sides of the X direction. In the present embodiment, the first exterior line LX1A and the fourth exterior line LX4A overlap with each other in a plan view, and the second exterior line LY2A and the fifth exterior line LY5A overlap with each other in a plan view.

### Manufacturing Method for Optoelectronic Device 100A

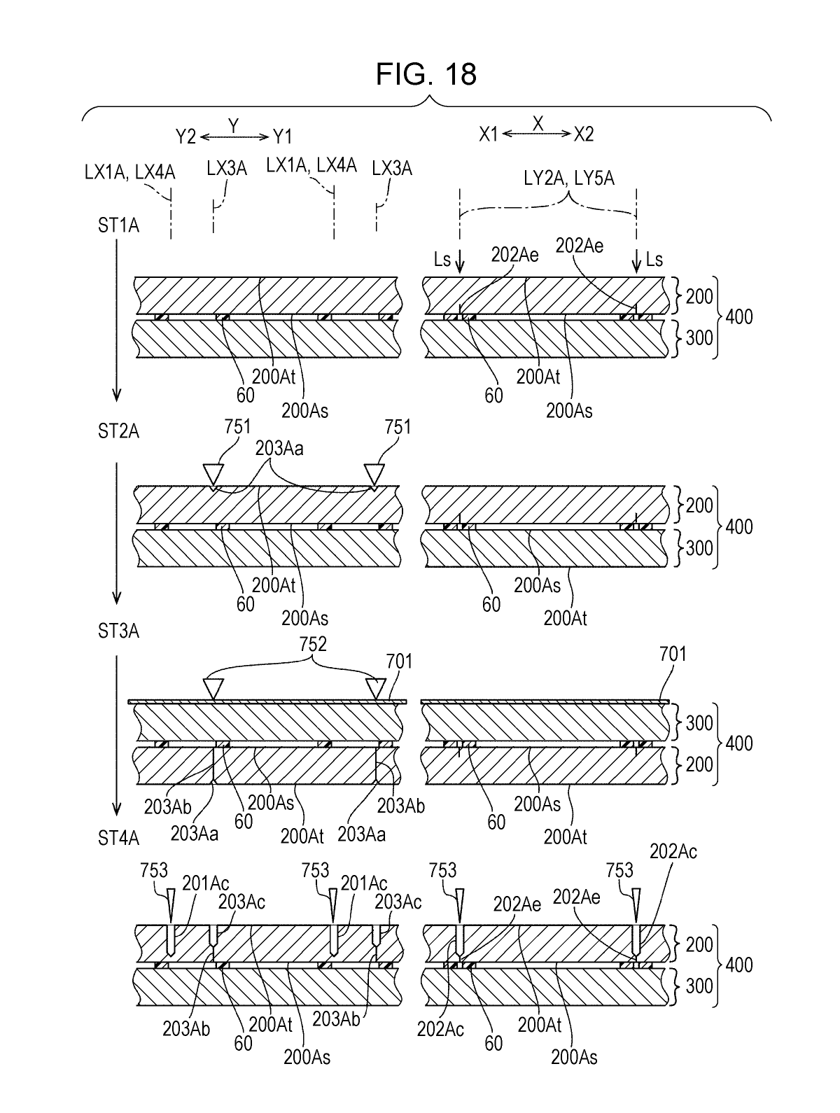

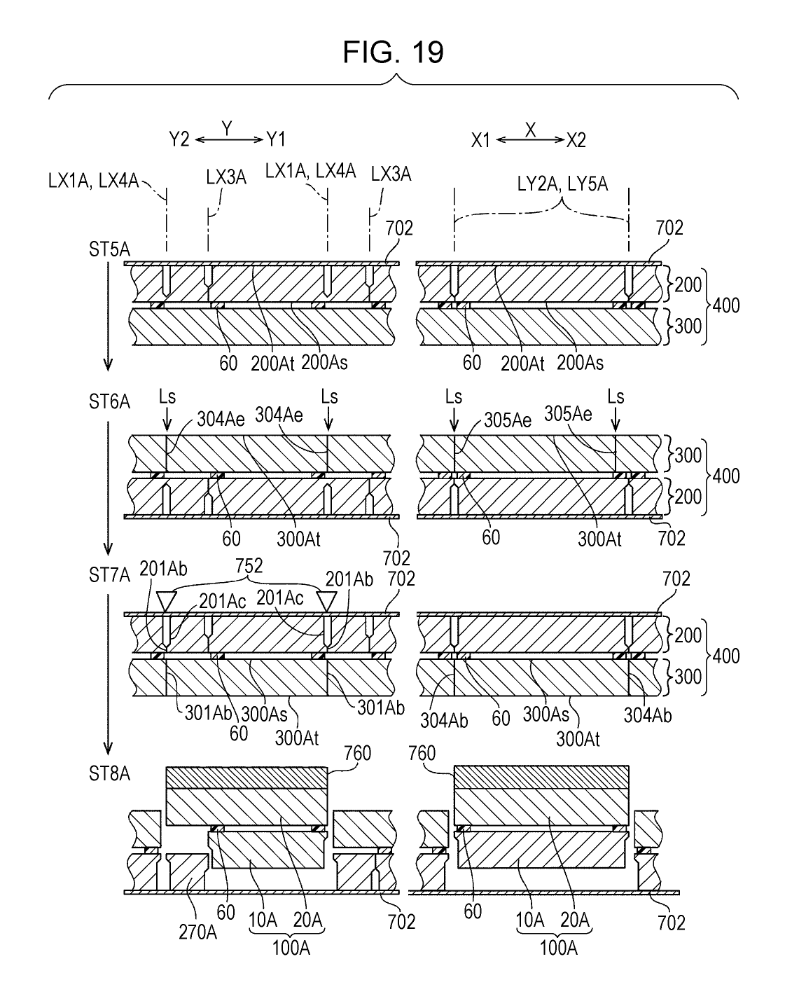

FIG. 18 and FIG. 19 are sectional step views illustrating a manufacturing method for the optoelectronic device 100A illustrated in FIG. 11. In FIG. 18 and FIG. 19, the Y0-Y0′ section is illustrated on the left side of the drawings, and the X0-X0′ section is illustrated on the right side of the drawings. In FIG. 18 and FIG. 19, the optoelectronic layer 50 and the like are not illustrated.

As described below with reference to FIG. 18 and FIG. 19, a first splitting step of splitting the first mother substrate 200 along the periphery 61 of the seal material 60 and a second splitting step of splitting the second mother substrate 300 along the periphery 61 of the seal material 60 are performed in the present embodiment. In addition, in the first splitting step, at least a first laser scribing process of forming a crack by laser scribing from the first inner surface 200As of the first mother substrate 200 to a midway position toward the first outer surface 200At and a dicing process of cleaving the first mother substrate 200 with a dicing saw from the first outer surface 200At to the crack are performed. In addition, in the first splitting step, furthermore, a breaking process of cleaving the first mother substrate 200 from the groove formed on the first outer surface 200At is performed. More specifically, as illustrated in FIG. 16, in the first splitting step, a first step ST10 of cleaving the first mother substrate 200 by a breaking process along the first exterior line LX1A, a second step ST20 of cleaving the first mother substrate 200 by the first laser scribing process and a dicing process along the second exterior line LY2A, and a third step ST30 of cleaving the first mother substrate 200 by a breaking process along the third exterior line LX3A are performed. In the first splitting step, a groove for breaking process is formed by a dicing saw in the first step ST10. In addition, after the third step ST30, a groove is formed by a dicing saw along the third exterior line LX3A. In the second splitting step, a second laser scribing process of forming a crack by laser scribing from the second outer surface 300At of the second mother substrate 300 to the second inner surface 300As is performed. More specifically, as illustrated in FIG. 16, in the second splitting step, a fourth step ST40 of cleaving the second mother substrate 300 by the second laser scribing process along the fourth exterior line LX4A and a fifth step ST50 of cleaving the second mother substrate 300 by the second laser scribing process along the fifth exterior line LY5A are performed.

More specifically, first, in a step ST1A illustrated in FIG. 18, the first mother substrate 200 is turned upward, and laser scribing that irradiates from the first inner surface 200As to a midway position toward the first outer surface 200At with a laser spot Ls configured of a pulse laser along the second exterior line LY2A in the first mother substrate 200 is performed to form a crack 202Ae (first laser scribing process).

Next, in a step ST2A illustrated in FIG. 18, a scribe groove 203Aa that extends along the third exterior line LX3A is formed on the first outer surface 200At of the first mother substrate 200 by the scribe head 751 that includes a diamond cutter or a cemented carbide cutter.

Next, in a step ST3A illustrated in FIG. 18, the second mother substrate 300 is turned upward, the first adhesive sheet 701 is bonded to the second outer surface 300At of the second mother substrate 300, and then the second mother substrate 300 is pressed by the breaking bar 752 through the first adhesive sheet 701. Consequently, load is exerted on the first mother substrate 200 to generate stress, and a cleaved surface 203Ab reaches the first inner surface 200As of the first mother substrate 200 from the scribe groove 203Aa. Accordingly, the first mother substrate 200 is cleaved along the third exterior line LX3A (third step ST30).

Next, in a step ST4A illustrated in FIG. 18, a dicing process is performed for the first mother substrate 200 on the first exterior line LX1A, the second exterior line LY2A, and the third exterior line LX3A. More specifically, first, in the step ST4A illustrated in FIG. 18, the first adhesive sheet 701 is removed, and then the first mother substrate 200 is turned upward, and a dicing process is performed for the first mother substrate 200 on the second exterior line LY2A. At this point, on the second exterior line LY2A, the dicing saw 753 is rendered to advance from the first outer surface 200At of the first mother substrate 200 to the crack 202Ae, and a dicing groove 202Ac is formed in the first mother substrate 200. Consequently, the first mother substrate 200 is cleaved along the second exterior line LY2A (second step ST20).

In addition, on the first exterior line LX1A, the dicing saw 753 is rendered to advance from the first outer surface 200At of the first mother substrate 200 to a midway position in the thickness direction, and a dicing groove 201Ac is formed in the first mother substrate 200 to the midway position in the thickness direction.

In addition, on the third exterior line LX3A, the dicing saw 753 is rendered to advance from the first outer surface 200At of the first mother substrate 200 to a midway position in the thickness direction, and a dicing groove 203Ac is formed in the first mother substrate 200 to the midway position in the thickness direction.

Next, in a step ST5A illustrated in FIG. 19, the first mother substrate 200 is turned upward, and the second adhesive sheet 702 is bonded to the first outer surface 200At of the first mother substrate 200. Next, in a step ST6A illustrated in FIG. 19, the second mother substrate 300 is turned upward, and laser scribing that irradiates from the second inner surface 300As to the second outer surface 300At with the laser spot Ls configured of a pulse laser along the fourth exterior line LX4A in the second mother substrate 300 is performed (second laser scribing process) to form a crack 304Ae. Consequently, the second mother substrate 300 is cleaved along the fourth exterior line LX4A (fourth step ST40). In addition, laser scribing that irradiates from the second inner surface 300As to the second outer surface 300At with the laser spot Ls along the fifth exterior line LY5A in the second mother substrate 300 is performed (second laser scribing process) to form a crack 305Ae. Consequently, the second mother substrate 300 is cleaved along the fifth exterior line LY5A (fifth step ST50).

Next, in a step ST7A illustrated in FIG. 19, the first mother substrate 200 is turned upward, and the first mother substrate 200 is pressed by the breaking bar 752 through the second adhesive sheet 702. Consequently, load is exerted on the first mother substrate 200 to generate stress, and a cleaved surface 201Ab reaches the first inner surface 200As of the first mother substrate 200 from the dicing groove 201Ac. Accordingly, the first mother substrate 200 is cleaved along the first exterior line LX1A (first step ST10).

Consequently, each of the first region 400a and the second region 400b is separated as the optoelectronic device 100A from the composite substrate 400. Accordingly, each of the first region 400a and the second region 400b is peeled and collected as the optoelectronic device 100A from the composite substrate 400 by the suction chuck 760. At this point, since the second adhesive sheet 702 is bonded to the first outer surface 200At of the first mother substrate 200 in the composite substrate 400, a split piece 270A that is split by the first exterior line LX1A, the second exterior line LY2A, and the third exterior line LX3A in the first mother substrate 200 remains on the adhesive sheet 702. In the optoelectronic device 100A configured as above, the first side surface 20Af of the first substrate 20A is formed by a part corresponding to the first exterior line LX1A. The first side surfaces 20Ag and 20Ah of the first substrate 20A is formed by a part corresponding to the second exterior line LY2A. The first side surface 20Ae of the first substrate 20A is formed by a part corresponding to the third exterior line LX3A. In addition, the second side surfaces 30Ae and 30Af of the second substrate 30A are formed by a part corresponding to the fourth exterior line LX4A, and the second side surfaces 30Ag and 30Ah of the second substrate 30A are formed by a part corresponding to the fifth exterior line LY5A.

### Main Effect of Present Embodiment

As described heretofore, in the present embodiment, laser scribing is used in splitting of the first mother substrate 200 and the second mother substrate 300, and thus chipping, burring, and the like of substrates are unlikely to occur. Accordingly, what is unlikely to occur is that terminals, interconnects, seal materials, and the like are damaged due to chipping, burring, and the like of substrates. In addition, in using of laser scribing in splitting of the first mother substrate 200, the crack 202Ae is formed by laser scribing from the first inner surface 200As of the first mother substrate 200 to a midway position, and the first mother substrate 200 is cleaved by the dicing saw 753 from the first outer surface 200At to the crack 202Ae. Thus, a section formed by the dicing saw 753 exists in the first substrate 20A split from the first mother substrate 200, and the position or the shape of such a section is highly accurate. Thus, when the optoelectronic device 100A is mounted on an electronic apparatus, the position of the optoelectronic device 100A can be aligned by using the section formed by the dicing saw 753 as a reference.

In addition, in the first splitting step of splitting the first mother substrate 200, furthermore, a breaking process of cleaving the first mother substrate 200 from the scribe groove 203Aa formed on the first outer surface 200At and from the dicing groove 201Ac is performed. In the case of a breaking process, substrates can be efficiently cleaved by laser scribing. Accordingly, if a breaking process is used in cleaving of a location where damage to terminals, interconnects, seal materials, and the like is unlikely to occur, the efficiency of manufacturing can be increased compared with the case of cleaving the entire substrate by laser scribing.

In addition, in the first splitting step of splitting the first mother substrate 200, the dicing grooves 201Ac, 202Ac, and 203Ac are formed by the dicing saw 753 on all of the first exterior line LX1A, the second exterior line LY2A, and the third exterior line LX3A. Thus, a section formed by the dicing saw 753 exists in all of the first side surfaces 20Ae, 20Af, 20Ag, and 20Ah of the first substrate 20A split from the first mother substrate 200. Thus, when the optoelectronic device 100A is mounted on an electronic apparatus, the position of the optoelectronic device 100A can be aligned by using the section formed by the dicing saw 753 as a reference.

In a manufacturing step such as the first splitting step or the second splitting step, pressure is likely to be exerted from the liquid-phase optoelectronic layer 50 on a seal material such as the seal material 60 or a film formed near the seal material 60, particularly in the case of using ODF when the optoelectronic layer 50 is disposed. However, according to the present embodiment, damage to a seal material can be prevented. Thus, even if pressure is exerted on the seal material from the liquid-phase optoelectronic layer 50 when the first splitting step or the second splitting step is performed, damage to the seal material can be prevented. Therefore, invasion of moisture to the optoelectronic layer 50 through the seal material or leaking of the optoelectronic layer 50 is unlikely to occur. A thick film is formed near the seal material 60 as the lens layer 241 is formed in the first substrate 20A. Thus, damage to the film near the seal material 60 is likely to occur when a dicing process is performed. However, according to the present embodiment, great vibrations are not exerted on the film near the seal material 60 at the time of a dicing process. Thus, even if a thick film exists near the seal material 60, damage to the film near the seal material 60 can be prevented. Therefore, invasion of moisture to the optoelectronic layer 50 through the seal material or leaking of the optoelectronic layer 50 is unlikely to occur.

When the optoelectronic device 100A is collected from the composite substrate 400, the split piece 270A produced in the first mother substrate 200 can be rendered to remain on the second adhesive sheet 702. Therefore, an advantage that the split piece 270A is not scattered is achieved. That is, since a breaking process on the first exterior line LX1A is performed after the second step ST20 and the third step ST30 in a state where the second adhesive sheet 702 is bonded to the first outer surface 200At of the first mother substrate 200, the split piece 270A can be held by the second adhesive sheet 702. Therefore, what is unlikely to occur is that the split piece 270A is scattered to damage terminals or interconnects. In addition, since cleaving of the dicing grooves 201Ac, 202Ac, and 203Ac by the dicing saw 753 for the first mother substrate 200 can be collectively performed in the same step ST4A, the efficiency of production can be improved.

### Other Embodiments

While the first side surfaces 20Ae and 20Af of the first substrate 20A are formed by a breaking process in the above embodiment, the first side surfaces 20Ae and 20Af of the first substrate 20A may be formed by a laser scribing process and a dicing process. In this case, on the first side surfaces 20Ae and 20Af of the first substrate 20A, the first part 207Aa and the second part 207Ab are formed instead of the third part 208Aa and the fourth part 208Ab. While a liquid crystal device is illustrated as the optoelectronic device 100A in the above embodiment, the invention may be applied to other optoelectronic devices such as an electrophoretic display device and an organic electroluminescent device.

### Example of Mounting on Electronic Apparatus

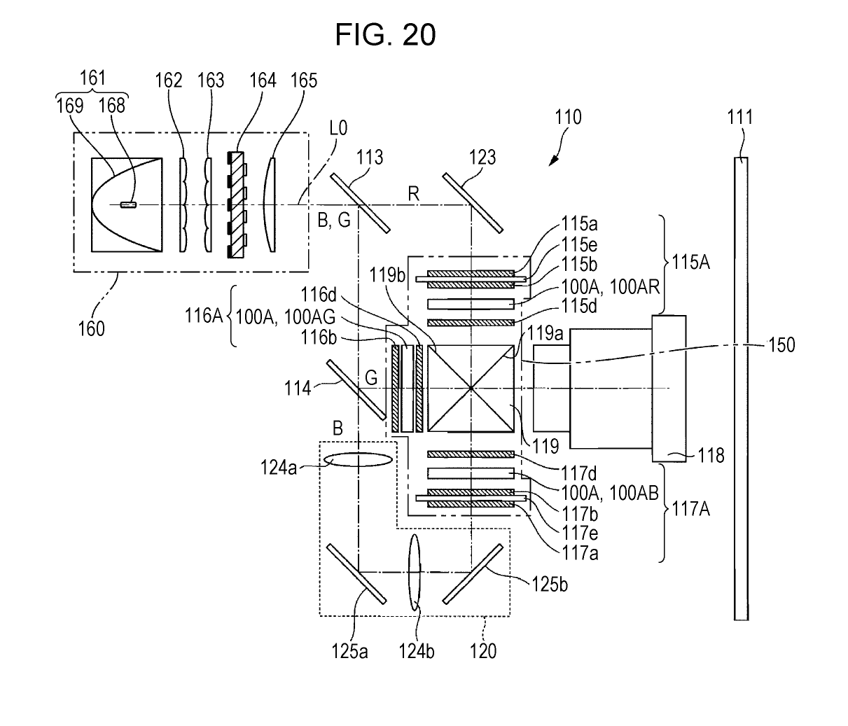

FIG. 20 is a schematic configuration diagram of a projection display apparatus (electronic apparatus) in which the optoelectronic device 100A to which the invention is applied is used. In the following description, a plurality of the optoelectronic devices 100A that is supplied with light in different wavelength regions is used. For any of the optoelectronic devices 100A, the optoelectronic device 100A to which the invention is applied is used.

A projection display apparatus 110A illustrated in FIG. 20 is a liquid crystal projector in which the transmissive optoelectronic device 100A is used, and irradiates the projection member 111 configured of a screen or the like with light to display an image. The projection display apparatus 110A has, along the apparatus optical axis L0, the illumination device 160, a plurality of the optoelectronic devices 100A (liquid crystal light valves 115A to 117A) that is supplied with light emitted from the illumination device 160, the cross dichroic prism 119 (light composition optical system) that combines and emits light emitted from the plurality of optoelectronic devices 100A, and the projection optical system 118 that projects light combined by the cross dichroic prism 119. In addition, the projection display apparatus 110 includes dichroic mirrors 113 and 114 and a relay system 120. In the projection display apparatus 110A, the optoelectronic device 100A and the cross dichroic prism 119 constitute an optical unit 150A.

The illuminant unit 161, the first integrator lens 162 that is configured of a lens array such as a fly's eye lens, the second integrator lens 163 that is configured of a lens array such as a fly's eye lens, the polarization conversion element 164, and the condenser lens 165 are arranged in the illumination device 160 in this order along the apparatus optical axis L0. The illuminant unit 161 includes the illuminant 168 and the reflector 169. The illuminant 168 emits white light that includes red light R, green light G, and blue light B. The illuminant 168 is configured of an extra-high-pressure mercury lamp, and the reflector 169 has a section of a parabolic shape. The first integrator lens 162 and the second integrator lens 163 render the illuminance distribution of light emitted from the illuminant unit 161 uniform. The polarization conversion element 164 turns the light emitted from the illuminant unit 161 into polarized light that has a specific direction of vibration such as s polarized light.

The dichroic mirror 113 transmits the red light R included in the light emitted from the illumination device 160 and reflects the green light G and the blue light B. The dichroic mirror 114, for the green light G and the blue light B reflected by the dichroic mirror 113, transmits the blue light B and reflects the green light G. The dichroic mirrors 113 and 114 constitute a color separation optical system that separates the light emitted from the illumination device 160 into the red light R, the green light G, and the blue light B.

The liquid crystal light valve 115A is a transmissive liquid crystal device that, according to an image signal, modulates the red light R which is transmitted by the dichroic mirror 113 and reflected by the reflective mirror 123. The liquid crystal light valve 115A includes the λ/2 retarder plate 115a, the first polarization plate 115b, the optoelectronic device 100A (red optoelectronic device 100AR), and the second polarization plate 115d. The red light R that is incident on the liquid crystal light valve 115A does not have the polarization thereof changed even if transmitted through the dichroic mirror 113, and thus remains as s polarized light.

The λ/2 retarder plate 115a is an optical element that converts the s polarized light incident on the liquid crystal light valve 115A into p polarized light. The first polarization plate 115b is a polarization plate that blocks s polarized light and transmits p polarized light. The optoelectronic device 100A (red optoelectronic device 100AR) is configured to convert p polarized light into s polarized light (circularly polarized light or elliptically polarized light in the case of halftone) by modulating p polarized light according to an image signal. The second polarization plate 115d is a polarization plate that blocks p polarized light and transmits s polarized light. Accordingly, the liquid crystal light valve 115A modulates the red light R according to an image signal and emits the modulated red light R toward the cross dichroic prism 119. The λ/2 retarder plate 115a and the first polarization plate 115b are arranged in a state of contact with the light-transmissive glass plate 115e that does not convert polarized light, and distortion of the λ/2 retarder plate 115a and the first polarization plate 115b by heat generation can be avoided.

The liquid crystal light valve 116A is a transmissive liquid crystal device that, according to an image signal, modulates the green light G which is reflected by the dichroic mirror 113 and then reflected by the dichroic mirror 114. The liquid crystal light valve 116A, in the same manner as the liquid crystal light valve 115A, includes the first polarization plate 116b, the optoelectronic device 100A (green optoelectronic device 100AG), and the second polarization plate 116d. The green light G that is incident on the liquid crystal light valve 116A is s polarized light that is incident after reflected by the dichroic mirrors 113 and 114. The first polarization plate 116b is a polarization plate that blocks p polarized light and transmits s polarized light. The optoelectronic device 100A (green optoelectronic device 100AG) is configured to convert s polarized light into p polarized light (circularly polarized light or elliptically polarized light in the case of halftone) by modulating s polarized light according to an image signal. The second polarization plate 116d is a polarization plate that blocks s polarized light and transmits p polarized light. Accordingly, the liquid crystal light valve 116A modulates the green light G according to an image signal and emits the modulated green light G toward the cross dichroic prism 119.

The liquid crystal light valve 117A is a transmissive liquid crystal device that, according to an image signal, modulates the blue light B which is reflected by the dichroic mirror 113 and transmitted by the dichroic mirror 114 and then passes through the relay system 120. The liquid crystal light valve 117A, in the same manner as the liquid crystal light valves 115A and 116A, includes the λ/2 retarder plate 117a, the first polarization plate 117b, the optoelectronic device 100A (blue optoelectronic device 100AB), and the second polarization plate 117d. The blue light B that is incident on the liquid crystal light valve 117A is reflected by the dichroic mirror 113, transmitted by the dichroic mirror 114, and then reflected by the two reflective mirrors 125a and 125b of the relay system 120, and thus is s polarized light.

The λ/2 retarder plate 117a is an optical element that converts the s polarized light incident on the liquid crystal light valve 117A into p polarized light. The first polarization plate 117b is a polarization plate that blocks s polarized light and transmits p polarized light. The optoelectronic device 100A (blue optoelectronic device 100AB) is configured to convert p polarized light into s polarized light (circularly polarized light or elliptically polarized light in the case of halftone) by modulating p polarized light according to an image signal. The second polarization plate 117d is a polarization plate that blocks p polarized light and transmits s polarized light. Accordingly, the liquid crystal light valve 117A modulates the blue light B according to an image signal and emits the modulated blue light B toward the cross dichroic prism 119. The λ/2 retarder plate 117a and the first polarization plate 117b are arranged in a state of contact with the glass plate 117e.

The relay system 120 includes the relay lenses 124a and 124b and the reflective mirrors 125a and 125b. The relay lenses 124a and 124b are disposed in order to prevent loss of light due to a long optical path for the blue light B. The relay lens 124a is arranged between the dichroic mirror 114 and the reflective mirror 125a. The relay lens 124b is arranged between the reflective mirrors 125a and 125b. The reflective mirror 125a reflects, toward the relay lens 124b, the blue light B which is transmitted by the dichroic mirror 114 and emitted from the relay lens 124a. The reflective mirror 125b reflects, toward the liquid crystal light valve 117A, the blue light B which is emitted from the relay lens 124b.

The cross dichroic prism 119 is a color composition optical system in which the two dichroic films 119a and 119b are orthogonally arranged in an X shape. The dichroic film 119a is a film that reflects the blue light B and transmits the green light G, and the dichroic film 119b is a film that reflects the red light R and transmits the green light G. Accordingly, the cross dichroic prism 119 combines the red light R, the green light G, and the blue light B which are respectively modulated by the liquid crystal light valves 115A to 117A, and emits the combined light toward the projection optical system 118.

Light that is incident on the cross dichroic prism 119 from the liquid crystal light valves 115A and 117A is s polarized light, and light that is incident on the cross dichroic prism 119 from the liquid crystal light valve 116A is p polarized light. By rendering the light incident on the cross dichroic prism 119 to be different types of polarized light, light that is incident on the cross dichroic prism 119 from each of the liquid crystal light valves 115A to 117A can be combined. Generally, the dichroic films 119a and 119b have excellent reflection characteristics for s polarized light. Thus, the red light R and the blue light B that are reflected by the dichroic films 119a and 119b are set to be s polarized light, and the green light G that is transmitted by the dichroic films 119a and 119b is set to be p polarized light. The projection optical system 118 has a projection lens (not illustrated) and projects the light combined by the cross dichroic prism 119 to the projection member 111 such as a screen.

### Other Projection Display Apparatuses

The above projection display apparatus may be configured in such a manner that LED illuminants and the like emitting light of each color are used as the illuminant unit and that each color light emitted from such LED illuminants is supplied to another liquid crystal device.

The optoelectronic device 100A to which the invention is applied may be used for, in addition to the above electronic apparatus, a projection head-up display (HUD), a direct view head-mounted display (HMD), a mobile phone, a mobile information terminal (personal digital assistants (PDA)), a digital camera, a liquid crystal television, a car navigation apparatus, a television phone, and the like.

This application claims priority from Japanese Patent Application Nos. 2016-028635 filed on Feb. 18, 2016 and 2016-166548 filed on Aug. 29, 2016 in the Japanese Patent Office, which are hereby incorporated by reference in their entirely.

What is claimed is:

1. A manufacturing method for an optoelectronic device that manufactures the optoelectronic device by splitting a composite substrate in which a first mother substrate and a second mother substrate are bonded to each other by a seal material disposed in a frame shape, the method comprising:
first splitting that splits the first mother substrate along the periphery of the seal material; and
second splitting that splits the second mother substrate along the periphery of the seal material,
wherein in the first splitting, a dicing process and a breaking process are performed for the first mother substrate, and
in the second splitting, the second mother substrate is processed.

2. The manufacturing method for an optoelectronic device according to claim 1,
wherein in the first splitting, a dicing process of cleaving the first mother substrate from a first outer surface to a midway position in the thickness direction and a first breaking process of cleaving the first mother substrate from a groove formed on the first outer surface of the first mother substrate are performed, the first outer surface being a surface on the opposite side of the first mother substrate from the second mother substrate, and
in the second splitting, a second breaking process of cleaving the second mother substrate from a groove formed on a second outer surface is performed, the second outer surface being a surface on the opposite side of the second mother substrate from the first mother substrate.

3. The manufacturing method for an optoelectronic device according to claim 2,
wherein the seal material is disposed in each of a first region and a second region that are adjacent in a first direction in the composite substrate,
in the second splitting, the second mother substrate is cleaved by the second breaking process along a first exterior line that extends in a second direction intersecting with the first direction along the periphery of the seal material, which is disposed in each of the first region and the second region, positioned on one side of the first direction,
in the first splitting, the first mother substrate is cleaved by the first breaking process along a second exterior line that extends in the second direction along the periphery of the seal material, which is disposed in each of the first region and the second region, positioned on the other side of the first direction, then the first mother substrate is cleaved by the first breaking process along a third exterior line that extends in the second direction along the periphery of the seal material, which is disposed in each of the first region and the second region, positioned on the one side of the first direction, and thereby the first mother substrate is split into each of the first region and the second region,
an adhesive sheet is bonded to the first outer surface when the first mother substrate is cleaved along the third exterior line, and
after the first mother substrate is cleaved along the third exterior line, the first region and the second region are peeled from the adhesive sheet in a state where the adhesive sheet is bonded to the first outer surface, and a split piece that is split by the second exterior line and the third exterior line in the first mother substrate is rendered to remain on the adhesive sheet.

4. The manufacturing method for an optoelectronic device according to claim 3,
wherein after the first mother substrate is cleaved along the second exterior line, the second mother substrate is cleaved along the first exterior line in a state where the adhesive sheet is bonded to the first outer surface, and then the first mother substrate is cleaved along the third exterior line.

5. The manufacturing method for an optoelectronic device according to claim 4,
wherein the dicing process is performed along the second exterior line and the third exterior line before the second mother substrate is cleaved along the first exterior line, and
in cleaving of the first mother substrate along the third exterior line, the first breaking process is performed from a groove that is formed along the third exterior line by the dicing process.

6. The manufacturing method for an optoelectronic device according to claim 1,
wherein in the first splitting, at least a first laser scribing process of forming a crack by laser scribing from a first inner surface to a midway position toward a first outer surface and a dicing process of cleaving the first mother substrate by a dicing saw from the first outer surface to the crack are performed, the first inner surface being a surface on the second mother substrate side of the first mother substrate and the first outer surface being a surface on the opposite side of the first mother substrate from the second mother substrate, and
in the second splitting, a second laser scribing process of forming a crack by laser scribing from a second outer surface to a second inner surface is performed, the second outer surface being a surface on the opposite side of the second mother substrate from the first mother substrate and the second inner surface being a surface on the first mother substrate side of the second mother substrate.

7. The manufacturing method for an optoelectronic device according to claim 6,
wherein in the first splitting, furthermore, a breaking process of cleaving the first mother substrate from a groove formed on the first outer surface is performed.

8. The manufacturing method for an optoelectronic device according to claim 7,
wherein given that one direction extending along the first outer surface is a first direction and that a direction intersecting with the first direction along the first outer surface is a second direction,
in the first splitting, first cleaving that cleaves the first mother substrate by the breaking process along a first exterior line extending in the second direction along the periphery of the seal material positioned on both sides of the first direction, second cleaving that cleaves the first mother substrate by the first laser scribing process and the dicing process along a second exterior line extending in the first direction along the periphery of the seal material positioned on both sides of the second direction, and third cleaving that cleaves the first mother substrate by the breaking process along a third exterior line extending on one side of the first direction in the seal material between the first exterior line and the seal material in the second direction along the periphery of the seal material positioned on the one side of the first direction are performed, and
in the second splitting, fourth cleaving that cleaves the second mother substrate by the second laser scribing process along a fourth exterior line extending in the second direction along the periphery of the seal material positioned on both sides of the first direction and fifth cleaving that cleaves the second mother substrate by the second laser scribing process along a fifth exterior line extending in the first direction along the periphery of the seal material positioned on both sides of the second direction are performed.

9. The manufacturing method for an optoelectronic device according to claim 8,
wherein when the first cleaving is performed after the second cleaving, the third cleaving, the fourth cleaving, and the fifth cleaving are performed, an adhesive sheet is bonded to the first outer surface, the first mother substrate is cleaved along the first exterior line, then an optoelectronic device that is split along the first exterior line, the second exterior line, the third exterior line, the fourth exterior line, and the fifth exterior line on the other side of the first direction in the seal material is peeled from the adhesive sheet, and a split piece that is split by the first exterior line, the second exterior line, and the third exterior line on the one side of the first direction in the seal material in the first mother substrate is rendered to remain on the adhesive sheet.

10. An optoelectronic device comprising:
a first substrate;
a second substrate that faces the first substrate and includes a terminal in an extending portion extending from the first substrate toward one side of a first direction;
a seal material of a frame shape that is disposed along a first side surface and bonds the first substrate and the second substrate to each other, the first side surface being a side surface of the first substrate; and
an optoelectronic layer that is disposed between the first substrate and the second substrate,
wherein the first side surface includes a first part from a first inner surface to a midway position toward a first outer surface and a second part from the midway position to the first outer surface, the first inner surface being a surface on the second substrate side of the first substrate and the first outer surface being a surface on the opposite side of the first substrate from the second substrate.

11. The optoelectronic device according to claim 10,
wherein the first side surface includes the first part that is formed from the first outer surface, which is a surface on the opposite side of the first substrate from the second substrate, to a midway position in the thickness direction and the second part that is formed to the first inner surface, which is a surface on the second substrate side of the first substrate, on the second substrate side of the first part and has lower light-scattering ability than the first part, and
a part of a second side surface that extends along the seal material includes a third part that is from a second inner surface to a midway position in the thickness direction and has lower light-scattering ability than the first part, the second side surface being a side surface of the second substrate and the second inner surface being a surface on the first substrate side of the second substrate.

12. The optoelectronic device according to claim 10,
wherein the first side surface includes the first part that is formed from the first outer surface, which is a surface on the opposite side of the first substrate from the second substrate, to a midway position in the thickness direction, a step portion that is adjacent to the first part on the second substrate side, and the second part that is formed from the step portion to the first inner surface, which is a surface on the second substrate side of the first substrate, and protrudes to the opposite side of the first part from the optoelectronic layer, and
a part of a second side surface that extends along the seal material includes a third part that is formed from a second outer surface to a midway position in the thickness direction and a fourth part that is formed from the third part to a second inner surface and is recessed to the optoelectronic layer side of the third part, the second side surface being a side surface of the second substrate, the second outer surface being a surface on the opposite side of the second substrate from the first substrate, and the second inner surface being a surface on the first substrate side of the second substrate.

13. The optoelectronic device according to claim 12,
wherein of the first side surfaces, either of a surface positioned on both sides of the first direction and a surface positioned on both sides of a second direction intersecting with the first direction includes the first part from the first inner surface, which is a surface on the second substrate side of the first substrate, to a midway position toward the first outer surface, which is a surface on the opposite side of the first substrate from the second substrate, and the second part from the midway position to the first outer surface, and
the periphery of the first substrate including the first part has a greater planar size than the periphery of the first substrate including the second part.

14. The optoelectronic device according to claim 13,
wherein of the second side surfaces which are side surfaces of the second substrate, either a surface positioned on the other side of the first direction or surfaces positioned on both sides of the second direction overlap with the first part in a plan view.

15. The optoelectronic device according to claim 13,
wherein a thermally modified part of a spot shape is distributed in the first part,
the thermally modified part is not distributed in the second part, and
the thermally modified part is distributed in, of the second side surfaces which are side surfaces of the second substrate, either surfaces positioned on both sides of the first direction or surfaces positioned on both sides of the second direction from the second inner surface, which is a surface on the first substrate side of the second substrate, to the second outer surface, which is a surface on the opposite side of the second substrate from the first substrate.

16. The optoelectronic device according to claim 15,
wherein the first part and the second part exist in, of the first side surfaces, surfaces positioned on both sides of the second direction, and
the thermally modified part is also distributed in, of the second side surfaces, either surfaces positioned on both sides of the first direction or surfaces positioned on both sides of the second direction.

17. The optoelectronic device according to claim 16,
wherein of the first side surfaces, surfaces positioned on both sides of the first direction include a third part that is formed from the first outer surface to a midway position toward the first inner surface and a fourth part that is from the third part to the first inner surface and has lower light-scattering ability than the third part.

18. The optoelectronic device according to claim 10,
wherein the seal material is continuous on the entire periphery, and
the optoelectronic layer is in a liquid phase.

19. The optoelectronic device according to claim 10,
wherein in the first substrate, a lens surface that is configured of a concave surface or a convex surface and a lens layer that covers the lens surface are disposed within a region surrounded by the seal material.

20. An electronic apparatus comprising:
the optoelectronic device according to claim 10.
